(19) United States
(12) Patent Application Publication
(10) Pub. No.: US 2016/0366662 A1
(43) Pub. Date: Dec. 15, 2016

(54) INFORMATION PROCESSING APPARATUS AND CONTROL PROGRAM

(71) Applicant: SHARP KABUSHIKI KAISHA, Sakai City (JP)

(72) Inventors: Keiichi KOBAYASHI, Sakai City (JP); Masayasu NAKAZAWA, Sakai City (JP); Koichi HIRATA, Sakai City (JP); Shusaku MIZUKAMI, Sakai City (JP); Takanori KONNO, Sakai City (JP); Yuji KAMON, Sakai City (JP)

(73) Assignee: SHARP KABUSHIKI KAISHA, Sakai City, Osaka (JP)

(21) Appl. No.: 15/118,017

(22) PCT Filed: Jan. 29, 2015
(86) PCT No.: PCT/JP2015/052535

§ 371 Date: Aug. 10, 2016

(30) Foreign Application Priority Data
Feb. 14, 2014 (JP) 2014-027025

(51) Int. Cl. H04W 60/06; H04L 29/08

(52) U.S. Cl. CPC H04W 60/06; H04L 67/143; H04N 21/43615

(57) ABSTRACT

A device appropriate as a target for cancellation of registration (pairing) is easily selected. A server (1) includes a pairing management unit (11) that selects a cancellation candidate among paired devices in a case where a request for pairing is received in a state where the number of pairing devices reaches an upper limit, and presents the cancellation candidate to a user to make the user select whether to cancel pairing of the cancellation candidate.

### TECHNICAL FIELD

The present invention relates to an information processing apparatus that receives a request for registration of a device in a content transmission system that transmits a content to a registered device which is registered in advance, and the like.

### BACKGROUND ART

In recent years, a technique for viewing a content, which is stored in a server within an in-house local area network (LAN), in each device connected to the in-house LAN has become widespread. In addition, a technique for acquiring a content by having access to an in-house server through a communication network, such as the Internet, from the outside of a house has also been developed.

However, in a case where a content is usable without limitation from the outside of a house, a problem such as a copyright occurs. Consequently, as disclosed in, for example, the following PTL 1, a configuration is considered in which only a fixed number of devices registered in advance are capable of receiving a content from the outside of a house.

### CITATION LIST

### Patent Literature

PTL 1: Japanese Unexamined Patent Application Publication No. 2012-4916 (published on Jan. 5, 2012)

PTL 2: Japanese Unexamined Patent Application Publication No. 2006-31097 (published on Feb. 2, 2006)

PTL 3: Japanese Unexamined Patent Application Publication No. 2001-326720 (published on Nov. 22, 2001)

PTL 4: Japanese Unexamined Patent Application Publication No. 2012-199753 (published on Oct. 18, 2012)

PTL 5: Japanese Unexamined Patent Application Publication No. 2011-278244 (published on Dec. 20, 2011)

### SUMMARY OF INVENTION

### Technical Problem

In a case where a fixed number of devices are capable of being registered, it is necessary to cancel the registration of at least one registered device when there is an attempt to register a new device in a state where the number of devices registered reaches an upper limit. However, it is not easy for many users to select a device appropriate for the cancellation of registration.

The invention is contrived in view of the above-mentioned problem, and an object thereof is to provide an information processing apparatus capable of easily selecting a device which is appropriate as a target for the cancellation of registration.

### Solution to Problem

In order to solve the above-mentioned problem, an information processing apparatus according to an aspect of the invention is an information processing apparatus that receives a request for registration of a device in a content transmission system that transmits a content to a registered device which is registered in advance in response to a request received from the registered device, the information processing apparatus including a cancellation candidate selection unit that selects a cancellation candidate which is a candidate for cancellation of registration among registered devices in a case where a request for registration is received in a state where the number of registered devices reaches an upper limit, and a candidate presentation unit that presents the cancellation candidate to a user to thereby make the user select whether to cancel registration of the cancellation candidate.

### Advantageous Effects of Invention

According to an aspect of the invention, an effect is exhibited which is capable of making it easier to select a device which is appropriate as a target for the cancellation of registration.

### BRIEF DESCRIPTION OF DRAWINGS

FIG. 1 is a block diagram showing main components of a server according to a first embodiment of the invention.

FIG. 2 is a diagram showing an outline of a content transmission system including the server.

FIG. 3 is a diagram showing an example of paired device management information.

FIG. 4 is a diagram showing an example of an in-house device list and a non-in-house device list.

FIG. 5 is a diagram showing an example of an image presented to a user.

FIG. 6 is a flow chart showing an example of a pairing process.

FIG. 7 is a diagram showing an outline of a content transmission system according to a reference example of the invention.

FIG. 8 is a diagram showing an operation sequence of each device included in the content transmission system.

FIG. 9 is a diagram showing an outline of a content transmission system according to another reference example of the invention.

FIG. 10 is a diagram showing an operation sequence of each device included in the content transmission system.

FIG. 11 is a diagram showing an outline of a content transmission system according to still another reference example of the invention.

FIG. 12 is a diagram showing an operation sequence of each device included in the content transmission system.

FIG. 13 is a diagram showing an outline of a content transmission system according to still another reference example of the invention.

FIG. 14 is a diagram showing an operation sequence of each device included in the content transmission system.

FIG. 15 is a diagram showing an outline of a content transmission system according to still another reference example of the invention.

FIG. 16 is a diagram showing an operation sequence of each device included in the content transmission system.

FIG. 17 is a diagram showing an operation sequence of each device included in a content transmission system according to still another reference example of the invention.

FIG. 18 is a diagram showing an operation sequence of each device included in a content transmission system according to still another reference example of the invention.

FIG. 19 is a diagram showing an operation sequence of each device included in a content transmission system according to still another reference example of the invention.

FIG. 20 is a diagram showing an operation sequence of each device included in a content transmission system according to still another reference example of the invention.

FIG. 21 is a diagram showing an operation sequence of each device included in a content transmission system according to still another reference example of the invention.

FIG. 22 is a diagram showing an operation sequence of each device included in a content transmission system according to still another reference example of the invention.

FIG. 23 is a diagram showing an operation sequence of each device included in a content transmission system according to still another reference example of the invention.

FIG. 24 is a diagram showing an operation sequence of each device included in a content transmission system according to still another reference example of the invention.

FIG. 25 is a diagram showing an outline of still another reference example of the invention.

FIG. 26 is a diagram showing an operation sequence of each device included in a content transmission system according to still another reference example of the invention.

### DESCRIPTION OF EMBODIMENTS

### First Embodiment

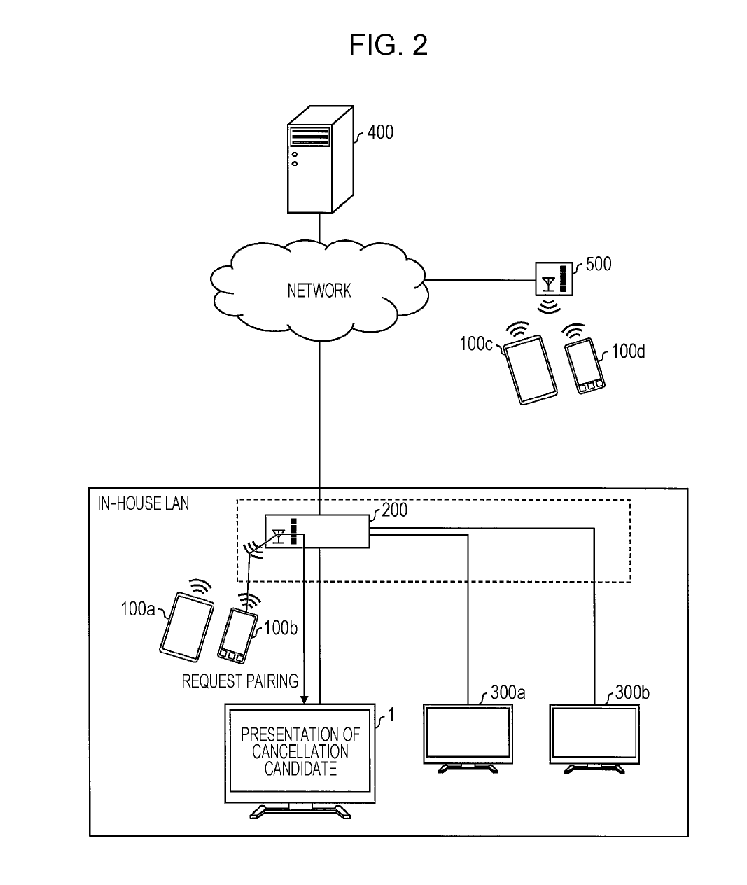

Hereinafter, embodiments of the invention will be described in detail. First, an outline of a content transmission system according to this embodiment will be described with reference to FIG. 2. FIG. 2 is a diagram showing an outline of the content transmission system.

Meanwhile, in this embodiment, a description will be given of an example in which a broadcasting content received by a server in a house in real time is transmitted to a client device outside a house. For example, the invention is not limited thereto, and such a content can be transmitted by using DTCP+. Thereby, a user can view the broadcasting content outside a house substantially in real time. Naturally, a transmission timing does not need to be substantial real time, and a content to be transmitted is not also limited to being a broadcasting content.

As shown in the drawing, the content transmission system includes a server (information processing apparatus, content transmission apparatus) 1, portable client devices (a device, a registered device, and a cancellation candidate) 100a to 100d, and stationary client devices 300a and 300b. Meanwhile, hereinafter, the portable client devices 100a to 100d may be simply referred to as client devices 100a to 100d or client devices.

In addition, the content transmission system includes a router 200 that connects an in-house local area network (LAN) and an out-of-house communication network (the Internet or the like), an access management server 400 for having access to the server 1 from the outside of a house, and an access point 500 for connecting with a network from the outside of a house. The out-of-house client devices 100c and 100d are connected to the access management server 400 through the access point 500, and acquire a communication address of the server 1 which is registered in the access management server 400 in advance to be able to communicate with the server 1.

The server 1 is a server that transmits a content to a client device in a house or the outside a house. The server 1 transmits a content to a client device which is a request source through an in-house LAN in a case where the content is requested by the client device 100a, 100b, 300a, or 300b in a house. In addition, the server 1 transmits a content to a client device which is a request source through an out-of-house communication network in a case where the content is requested by the out-of-house client device 100c or 100d.

Here, in a case where the server 1 receives a request for a content from the outside of a house, the server transmits the content only in a case where the request source thereof is a client device having been subjected to pairing in advance. In other words, the pairing means registration of a client device capable of receiving a content from the server 1 through a communication network outside a house (other than a LAN).

For this reason, in order to make it possible to receive a content from the outside of a house, the client devices 100a to 100d request pairing from the server in advance and need to be registered in the server 1 as devices capable of receiving a content from the outside of a house. Meanwhile, an example in which a request for pairing (request for registration) can be made only from the inside of a house is described here from a viewpoint of increasing security, but it is needless to say that a configuration in which pairing from the outside of a house can be performed may be adopted.

In addition, the server 1 sets a limitation to the number of client devices for which pairing can be performed. For this reason, when pairing of any client device is not canceled in a case where a request for pairing is further received in a state where the number of client devices having been subjected to pairing reaches an upper limit, it is not possible to perform pairing in response to the request for pairing.

Consequently, the server 1 automatically selects a candidate (hereinafter, referred to as a cancellation candidate) of a client device which is not likely to have a problem even when pairing is canceled, and presents the selected candidate to a user. Thereby, the user can easily select a client device which is appropriate for the cancellation of pairing (which is expected to have a low possibility of causing a trouble) and can pair a new client device with the server 1.

[Main Components of Server]

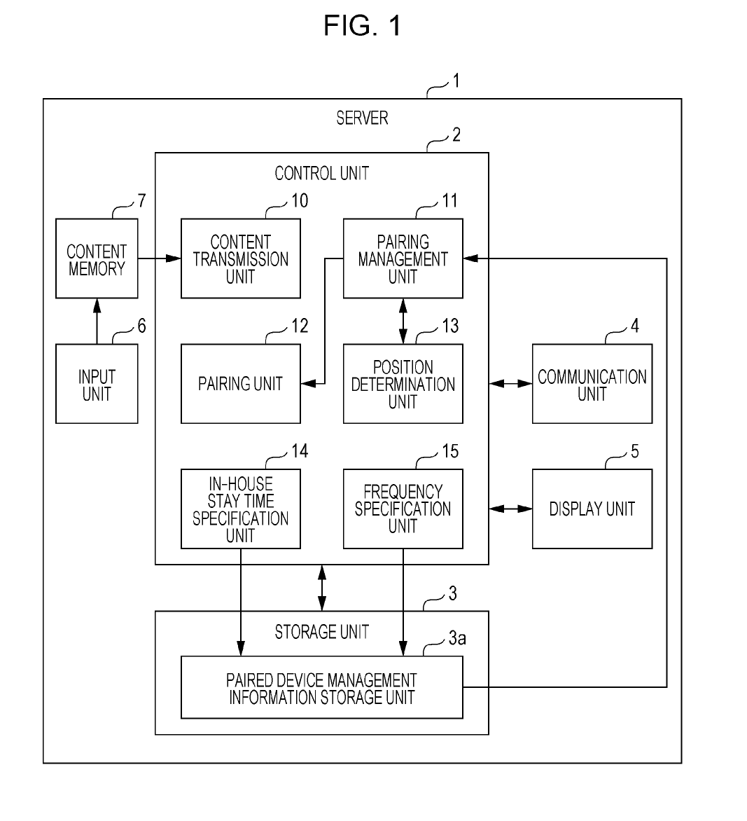

Next, a configuration of the server 1 will be described with reference to FIG. 1. FIG. 1 is a block diagram showing main components of the server 1. As shown in the drawing, the server 1 includes a control unit 2, a storage unit 3, a communication unit 4, a display unit 5, an input unit 6, and a content memory 7.

The control unit 2 collectively controls units of the server 1, and includes a content transmission unit 10, a pairing management unit (a cancellation candidate selection unit, a candidate presentation unit) 11, a pairing unit 12, a position determination unit (device detection unit) 13, an in-house stay time specification unit (stay time specification unit) 14, and a frequency specification unit (frequency specification unit) 15.

The storage unit 3 stores various pieces of data that are used in the server 1. The storage unit 3 shown in the drawing includes a paired device management information storage unit 3a. The communication unit 4 is used to make the server 1 communicate with another device, and the server 1 communicates with the client devices 100a to 100d and the like through the communication unit 4.

The input unit 6 inputs a content acquired from the outside to the content memory 7. Specifically, the input unit 6 is a tuner that acquires a content from a broadcast wave received by the server 1 and inputs the acquired content to the content memory 7. Meanwhile, the input unit 6 is not particularly limited as long as the unit can input a content to the content memory 7. For example, the input unit 6 may acquire a content from a storage device such as a hard disk or a recording medium such as a BD disk and may input the acquired content to the content memory 7. The content memory 7 is a memory that stores a content which is output from the input unit 6.

The display unit 5 is a display device that displays an image under the control of the control unit 2. In other words, the server 1 has a function as a television receiver that receives and displays a broadcasting content. Meanwhile, the display unit 5 and the input unit 6 may be an external device which is externally connected to the server 1.

The paired device management information storage unit 3a stores paired device management information for managing a paired client device. The paired device management information will be described later in detail.

The content transmission unit 10 transmits a content in response to a request received from a client device. However, in a case where a transmission request of a content is received from the outside of a house, the content transmission unit 10 confirms whether or not a device which is a transmission source of the request is registered in paired device management information, and transmits a content only in a case where the device is registered.

The pairing management unit 11 performs a process related to pairing between the server 1 and a client device. Specifically, in a case where the pairing management unit 11 receives a request for pairing in a state where the number of paired devices does not reach an upper limit, the pairing management unit instructs the pairing unit 12 to perform pairing with the device. On the other hand, in a case where the pairing management unit receives a request for pairing in a state where the number of paired devices reaches an upper limit, the pairing management unit 11 selects a cancellation candidate which is a candidate for the cancellation of pairing among registered client devices. In addition, the pairing management unit 11 presents the selected cancellation candidate to a user to make the user select whether or not pairing of the cancellation candidate can be canceled (registration can be canceled). Meanwhile, the selection and presentation of a cancellation candidate may be performed in a different processing block.

The pairing unit 12 performs pairing with a client device in accordance with an instruction of the pairing management unit 11. Specifically, the pairing unit 12 registers a communication address and a device ID of a client device presented by the pairing management unit 11 to thereby perform pairing with the client device.

The position determination unit 13 determines whether or not each of paired client devices is present in a house. Specifically, the position determination unit 13 transmits a request for a response to each device within an in-house LAN, and determines whether or not a device having responded to the request is present in a house. In other words, the position determination unit 13 detects a client device being connected to the in-house LAN among paired client devices. Meanwhile, a method of determining presence or absence in a house is not limited thereto. For example, in a case where client device includes a global positioning system (GPS) receiver or the like, the client device is made to transmit positional information of the device. When a position indicated by the positional information is within a predetermined range from the position of the server 1, it may be determined that the device is present in a house.

The in-house stay time specification unit 14 specifies a cumulative time of the presence of each of paired client devices in a house, and records the specified cumulative time as an in-house stay time of the client device. Meanwhile, here, an example in which a cumulative time of connection to an in-house LAN is set as a cumulative time of presence in a house will be described. For example, a cumulative time of presence at a position capable of being connected to an in-house LAN is specified using the above-mentioned positional information or the like, and the specified cumulative time may be set as an in-house stay time of presence in a house.

The frequency specification unit 15 specifies the frequency of acquisition of a content from the outside of a house of each of paired client devices, and records the specified frequency. Meanwhile, here, a description is given of an example in which the number of times of reception of a request for transmission of a content from the outside of a house for a predetermined period of time (for example, one day) is recorded as information indicating the frequency, and the recorded information is not limited to this example as long as the information indicates the frequency of acquisition of a content from the outside of a house.

[Paired Device Management Information]

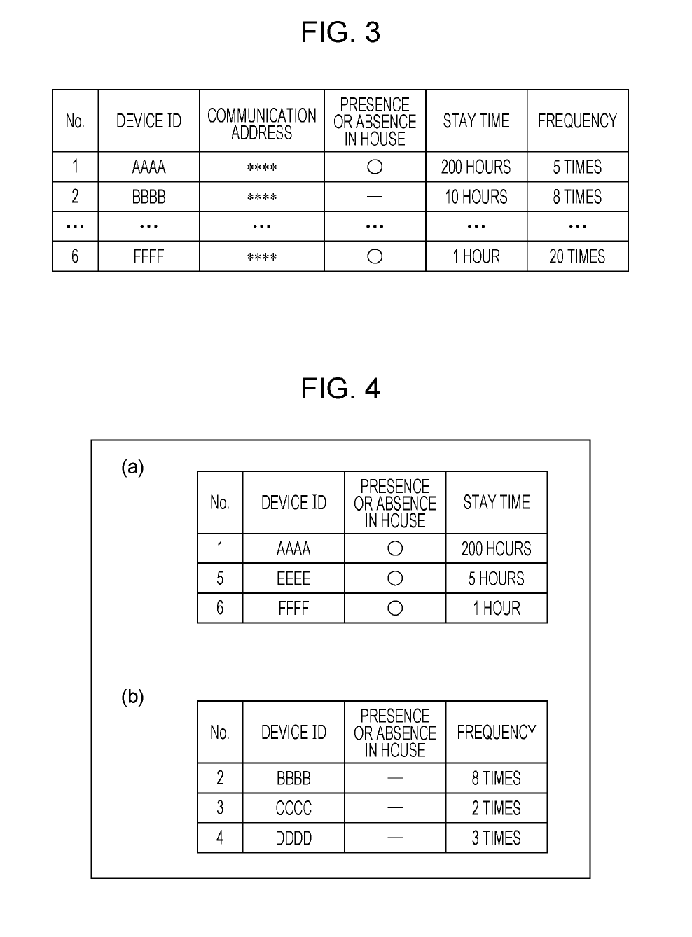

Subsequently, paired device management information will be described in detail with reference to FIG. 3. FIG. 3 is a diagram showing an example of paired device management information. The paired device management information shown in the drawing is information in a table format in which a device ID, a communication address, information indicating presence or absence in a house, information indicating an in-house stay time, and information indicating the frequency of acquisition of a content from the outside of a house are associated with each other.

The device ID is identification information for identifying a client device. The device ID may be information capable uniquely identifying each paired client device, and may be, for example, a device name which is set by a user in advance, a user name of the device, a device type name of the device, or the like. In addition, a communication address is a communication address for communication with the client device. It is possible to transmit a content to a client device outside a house by using the communication address. These pieces of information are recorded, for example, at the time of pairing.

The information indicating presence or absence in a house is information indicating whether or not a client device is present in a house. As described above, the position determination unit 13 determines whether or not a client device is present in a house. In addition, the position determination unit 13 records a result of the determination in the paired device management information as information indicating whether or not the client device is present in a house. Meanwhile, information indicating whether or not a client device is present in a house may be recorded as data different from the paired device management information.

The information indicating an in-house stay time is information indicating a cumulative time of the presence of a client device in a house. As described above, the cumulative time of a client device in a house is specified by the in-house stay time specification unit 14. In addition, the in-house stay time specification unit 14 records a result of the specification in the paired device management information as information indicating an in-house stay time of the client device. Meanwhile, the information indicating an in-house stay time may be recorded as data different from the paired device management information.

The information indicating the frequency of acquisition of a content from the outside of a house is information indicating the frequency at which a client device acquires a content from the server 1 outside a house. As described above, the frequency of acquisition of a content from the outside of a house is specified by the frequency specification unit 15. In addition, the frequency specification unit 15 records a result of the determination in the paired device management information as information indicating the frequency of acquisition of a content from the outside of a house of the client device. Meanwhile, the information indicating the frequency of acquisition of a content from the outside of a house may be recorded as data different from the paired device management information.

[Pairing Process]

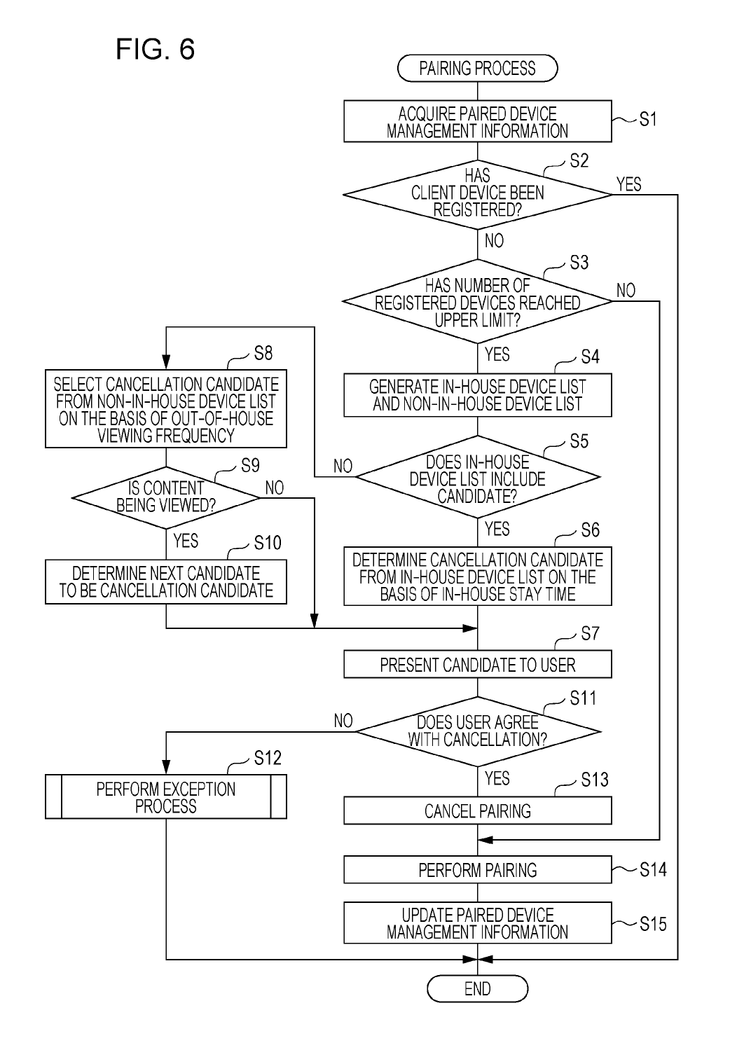

Next, a flow of a pairing process performed by the server 1 will be described with reference to FIG. 6. FIG. 6 is a flow chart showing an example of a pairing process. Meanwhile, a process in the drawing is started upon receiving a request for pairing from a client device. In addition, it is assumed that the server 1 receives a device ID of the client device together with the request for pairing.

First, the pairing management unit 22 acquires paired device management information from the paired device management information storage unit 3a (S1), and determines whether or not a client device which is a pairing request source is registered in paired device management information (S2). Here, in a case where it is determined that the client device is registered (YES in S2), the pairing management unit 22 terminates the pairing process without performing pairing. On the other hand, in a case where it is determined that the client device is not registered (NO in S2), the pairing management unit 22 determines whether or not the number of registered devices reaches an upper limit (S3).

Here, in a case where it is determined that the number of registered devices does not reach the upper limit (NO in S3), the pairing management unit 22 instructs the pairing unit 23 to perform pairing with the client device (S14), updates the paired device management information (S15), and terminates the pairing process. On the other hand, in a case where the number of registered devices reaches the upper limit (YES in S3), the pairing management unit 22 instructs the position determination unit 24 to determine whether or not each registered device is present in a house. In addition, the pairing management unit 22 generates an in-house device list which is a list of registered devices that are present in a house and a non-in-house device list which is a list of the other registered devices in accordance with results of the determination (S4).

Meanwhile, the in-house device list and the non-in-house device list may be, for example, lists shown in FIG. 4. FIG. 4 is a diagram showing an example of an in-house device list and a non-in-house device list. The in-house device list shown in (a) of the drawing is a list generated by extracting records indicating presence or absence in a house being “◯” from the paired device management information of FIG. 3, that is, records related to a client device which is detected being connected to an in-house LAN. In this example, a cancellation candidate is determined from the in-house device list on the basis of an in-house stay time, and thus information indicating a stay time is also extracted from the paired device management information. In addition, the non-in-house device list shown in (b) of the drawing is a list generated by extracting records indicating presence or absence in a house being “-” from the paired device management information of FIG. 3, that is, records related to a client device which is not detected being connected to an in-house LAN. In this example, a cancellation candidate is determined from the non-in-house device list on the basis of the frequency of acquisition of a content from the outside of a house, and thus information indicating the frequency is also extracted from the paired device management information.

Next, the pairing management unit 22 determines whether or not a device is included in the generated in-house device list (S5). Here, in a case where a candidate is included in the in-house device list (YES in S5), the pairing management unit 22 determines a pairing cancellation candidate from the in-house device list on the basis of the information indicating an in-house stay time (S6). Specifically, the pairing management unit 22 sorts the in-house device list in descending order with the in-house stay time as a key and determines a device at the heat, that is, a device having the longest in-house stay time to be a pairing cancellation candidate. In addition, the pairing management unit 22 presents the determined pairing cancellation candidate to a user, for example, by displaying the pairing cancellation candidate on the display unit 5 (S7).

On the other hand, in a case where the in-house device list does not include a candidate (NO in S5), the pairing management unit 22 selects a cancellation candidate from the non-in-house device list on the basis of the information indicating the frequency of acquisition of a content from the outside of a house (S8). Specifically, the pairing management unit 22 sorts the non-in-house device list in ascending order with the frequency as a key and selects a device at the head, that is, a device having the lowest frequency.

Next, the pairing management unit 22 determines whether or not a content is being viewed by the selected device (S9). Specifically, in a case where a device to which the distribution unit 21 transmits a content and the device selected in S8 conform to each other, it is determined that a content is being viewed by the device.

Here, in a case where it is determined that a content is not being viewed (NO in S9), the flow proceeds to the process of S7 to present the cancellation candidate selected in S8 to a user. On the other hand, in a case where it is determined that a content is being viewed (YES in S9), the pairing management unit 22 determines the next candidate to be a cancellation candidate (S10), and the flow proceeds to the process of S7 to present the cancellation candidate to a user.

Meanwhile, the next candidate is a device having the second lowest frequency among devices included in the non-in-house device list. In addition, here, it is assumed that the number of devices capable of receiving a content distributed from the server 1 from the outside of a house is limited to being one, and thus a content distributed from the server 1 cannot be viewed even by the device having the second lowest frequency. However, when the above-mentioned limitation is not set, the determination in S9 may be performed sequentially on the device having the second lowest frequency and devices having a lower frequency, until a device by which a content is not viewed is found out.

In S7, a cancellation candidate for pairing is presented to a user, and then the pairing management unit 22 determines whether or not the user has agreed with the cancellation of pairing of the cancellation candidate (S11). For example, options for selecting whether to perform cancellation are displayed on the display unit 5, and a user may perform the determination in accordance with contents selected by the user.

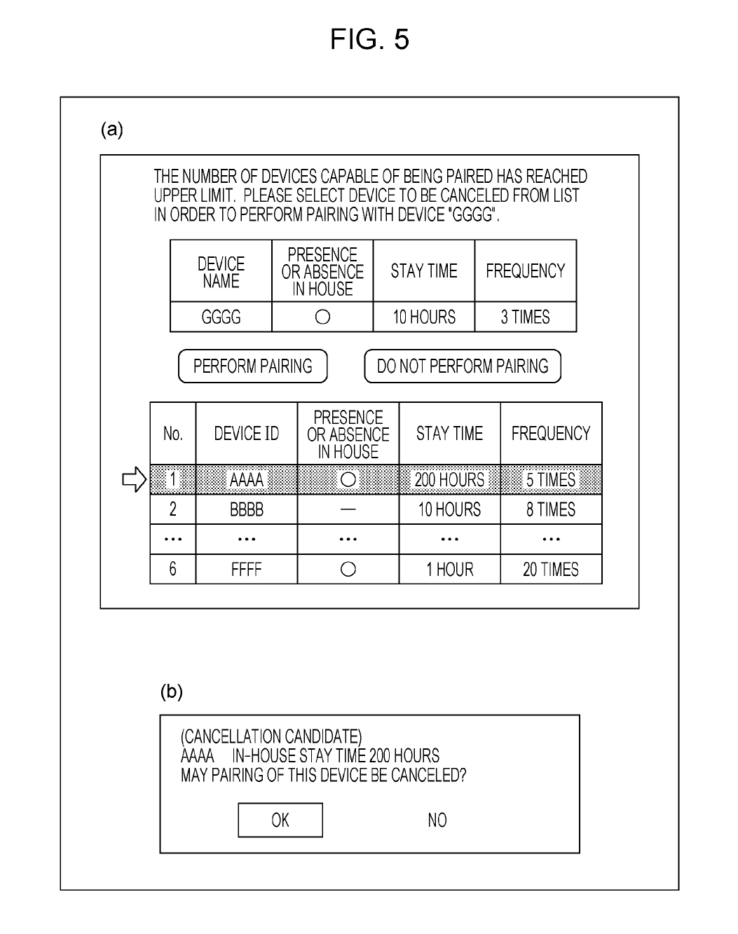

Here, in a case where it is determined that a user has not agreed with the cancellation of pairing of a cancellation candidate (NO in S11), the pairing management unit 22 performs an exception process (S12) and terminates the pairing process. In the exception process, a process of presenting the next cancellation candidate (for example, a device having the second longest in-house stay time next to a cancellation candidate that has not obtain agreement, or a device having a low frequency of acquisition of a content from the outside of a house which is next to a cancellation candidate that has not obtain agreement) to a user may be iterated until the user's agreement is obtained. In addition, in the exception process, after a list having registered devices being displayed together with their respective pieces of information, such as presence or absence in a house, an in-house stay time, and a frequency, is displayed (FIG. 5(a)), a user may be prompted to select a device for which pairing is canceled, a user may select a device for which pairing is canceled, or required pairing may be performed without performing cancellation of pairing.

On the other hand, in a case where it is determined that the user has agreed with the cancellation of pairing of the cancellation candidate (YES in S11), the pairing management unit 22 deletes a device which is the cancellation candidate from the paired device management information to cancel pairing with the device (S13). In addition, the pairing management unit 22 instructs the pairing unit 23 to perform pairing with a client device (S14), updates the paired device management information (S15), and terminates the pairing process.

Meanwhile, in S7 mentioned above, presentation to a user may be performed using, for example, an image as shown in (a) of FIG. 5. In S11, it may be determined whether a user has agreed with cancellation in accordance with, for example, the user's response to an image as shown in (b) of FIG. 5. FIG. 5 is a diagram showing an example of an image presented to a user.

The image shown in (a) of the drawing includes a message indicating that the number of devices capable of being paired has reached an upper limit and that it is necessary to select a device for which pairing is canceled in order to perform new pairing. In addition, the image includes a device ID of a device having received a request for pairing, and the like. Meanwhile, even when pairing is canceled, information indicating that pairing has been canceled is given and is left in paired device management information without deleting information regarding the client device from the paired device management information. Accordingly, in a case where the device having received a request for pairing was paired with the server 1 in the past, it is possible to present a stay time and the like as in the example shown in the drawing. Naturally, information such as a stay time does not necessarily need to be presented.

In addition, the image shown in (a) of the drawing includes options for selecting whether to perform pairing and a list of paired devices. In addition, in the list, a cancellation candidate determined by the server 1 is focused (highlighted), and a cursor (arrow) for making a user select a device to be canceled is positioned at the cancellation candidate.

In this manner, an image capable of making a user easily identify and select a cancellation candidate determined by the server 1 from the list of paired devices is displayed, and thus the user can easily select an appropriate cancellation candidate. Meanwhile, only a cancellation candidate determined by the server 1 may be presented to a user, but it is preferable to expand the range of the user's selection by displaying the other devices so as to be selectable. In addition, in the example shown in the drawing, one cancellation candidate determined by the server 1 is highlighted, but a plurality of cancellation candidates may be similarly presented by being highlighted or may be presented in order in which the cancellation candidates are considered to be more appropriate cancellation candidates.

In addition, in a case where a device is selected from the above-mentioned list, the image as shown in (b) of the drawing may be displayed so that a user confirms whether to cancel pairing with the selected device. In the image shown in (b) of the drawing, an ID of a device selected by a user, information indicating that the device is set as a cancellation candidate of pairing, and an in-house stay time of the device which is a reference point of determination for selecting the device as a cancellation candidate are shown. In addition, the image includes a message for inquiring whether to cancel pairing of the device and options for selecting whether to cancel the pairing of the device. Such an image is displayed, and thus a user can recognize that a device which has a long in-house stay time, is less likely to be used for the viewing of a content outside a house, or has a tendency to be paired again from the inside of a house when necessary is set as a cancellation candidate. In addition, it is possible to perform final determination of whether pairing with the device is canceled, under such recognition.

Meanwhile, the images shown in (a) and (b) of FIG. 5 may be displayed on a client device, and the server 1 may receive a user's input contents, which are input to the client device, to perform the determination in S11, on the basis of the images from the client device.

In the above-mentioned example, a registered client device which is present in a house is set as a cancellation candidate in preference to a client device of which the presence in a house has not been confirmed. This is because a client device connected to an in-house LAN can receive a desired content from the server 1 even when pairing of client device is canceled. In addition, as described above, here, it is assumed that pairing can be performed only in a state of connection to an in-house LAN. For this reason, even when pairing of a client device against a user's intention is canceled, it is possible to promptly perform pairing again. From this point, it can be said that the above-described configuration in which a registered client device present in a house is preferentially set as a cancellation candidate is preferable.

### Second Embodiment

In the above-described embodiment, a description has been given of an example in which a client device having the longest in-house stay time shown in a reference point (2) mentioned below is set as a cancellation candidate among client devices determined to be present in a house on the basis of a reference point (1) mentioned below. In addition, a description has been given of an example in which a client device having the lowest frequency of acquisition of a content from the outside of a house which is shown in a reference point (3) mentioned below is set as a cancellation candidate among client devices determined not to be present in a house on the basis of the reference point (1) mentioned below.

(1) Presence or absence in a house (a device in a house is preferentially set as a cancellation candidate)

(2) In-house stay time (a client device having a long in-house stay time is preferentially set as a cancellation candidate)

(3) Frequency of acquisition outside a house (a client device having a low frequency of acquisition of a content from the outside of a house is preferentially set as a cancellation candidate)

However, a cancellation candidate does not necessarily need to be selected by the above-mentioned combination. For example, all client devices determined in (1) to be present in a house may be set as cancellation candidates. In addition, a cancellation candidate may be determined by only the reference point (2) or (3) or a combination of the reference points, without using the reference point (1). Further, a cancellation candidate may be determined by a combination of all of the reference points (1) to (3).

In addition, a reference point of the selection of a cancellation candidate is not limited to the examples of (1) to (3) mentioned above. For example, a client device having a long period (period elapsed since a recent use time) for which viewing (reception of a content from the server 1) is not performed outside a house may be preferentially set as a cancellation candidate. This is because a client device which is not used for viewing outside a house over a long period of time is often less influenced even when pairing thereof is canceled.

In this case, the server 1 may be provided with a non-reception period specification unit (non-reception period specification unit) which acquires non-reception period information indicating a period of time for which a client device does not receive a content from the server 1 outside an in-house LAN. In addition, the pairing management unit 11 may preferentially set a client device having a long period of time for which a content is not received, as a cancellation candidate on the basis of the non-reception period information. Meanwhile, a timing at which a content is finally received may be a timing at which a request for transmission of a content is received, may be a timing at which the transmission of a content is started, or may be a timing at which the transmission of a content is terminated. In addition, the timing may be indicated by a date and time or may be indicated by a date. Further, a cumulative non-reception period may be used instead of such a recent non-reception period.

In addition, for example, a priority of pairing may be set in a client device, and a client device having a low priority may be preferentially set as a cancellation candidate. The priority may be set on the basis of information regarding a paired client device being registered, for example, during the first pairing. In detail, for example, a parent-child relationship, an age, and the like may be registered with respect to a user of a client device. A parent may be determined to have a priority higher than that of a child, and an elder may be determined to have a priority higher than that of a youth. In addition, a user sets a priority, and a client device having a low priority may be preferentially set as a cancellation candidate.

In this case, the server 1 may be provided with a priority determination unit (priority determination unit) which determines a priority of a client device on the basis of information regarding the client device which is registered in advance. In addition, the pairing management unit 11 may select a cancellation candidate on the basis of the priority determined by the priority determination unit.

In addition, for example, a client device having a shorter use time or a lower use frequency may be preferentially set as a cancellation candidate. This is because it is considered that a client device having a high use frequency has a great influence in a case where pairing is canceled, as compared to a client device having a low use frequency.

In this case, the server 1 may be provided with a use situation specification unit (use situation specification unit) which specifies a cumulative use time or a use frequency of a client device. In addition, the pairing management unit 11 may preferentially set a client device having a shorter cumulative use time or a client device having a lower use frequency which is specified by the use situation specification unit as a cancellation candidate. Meanwhile, for example, the cumulative use time may be obtained by measuring a time for which a client device is used (for example, a time for which a power supply is turned on and a sleep state is not set) and acquiring the measured time from the device. Similarly, for example, the use frequency may be obtained by counting the number of times of use of a client device (the number of times of use) (for example, the number of times of turn-on of a power supply or the cancellation of a sleep state) and acquiring the counted number of times. In addition, the number of times of use for predetermined period of time (for example, one day) may be set as the above-mentioned use frequency. In addition, the number of times or frequency of use (for example, use for viewing a content, the use of a specific application, or the like without being limited to the number of time or frequency of acquisition from the server 1) in a predetermined mode may be used.

It is possible to select an appropriate cancellation candidate by individually using or appropriately combining the above-mentioned various reference points.

[Cancellation of Request for Pairing]

A device requested to be paired has a lower priority of pairing in spite of being a cancellation candidate selected in the above-described manner, and thus it may be more appropriate to cancel the request for pairing than in a case where pairing is cancelled, on the basis of the above-mentioned reference points. In this case, the effect may be presented to a user to make the user select whether to cancel a request for pairing. Thereby, it is possible to prevent pairing of a device having a high priority from being canceled in order to perform pairing with a device having a low priority.

In this case, the server 1 may be provided with a priority determination unit (priority determination unit) which determines whether or not a device which is a transmission source of a request for pairing has a lower priority of registration than a paired client device in accordance with a predetermined reference point. In addition, the pairing management unit 11 notifies a user of a result of the determination in a case where the priority determination unit determines that the device which is a transmission source of a request for pairing has a lower priority of registration than the paired client device, to thereby make the user select whether to make a request for pairing. The above-mentioned reference point may be the same as a reference point for selecting a cancellation candidate.

Meanwhile, a cancellation candidate may be selected among all of the paired client devices and devices requested to be paired. In addition, after a cancellation candidate is selected, the degree of priority may be determined between the cancellation candidate and a device requested to be paired. In any of the configurations, it is possible to prevent the pairing of a client device having a high priority from being canceled.

[Automatic Cancellation]

In the above-described embodiment, a description has been given in which a cancellation candidate is presented to a user to make the user select whether to perform final cancellation, but the pairing of a cancellation candidate may be automatically cancelled without going through a user. In this case, the pairing management unit 11 selects one cancellation candidate in accordance with the above-mentioned reference point and cancels pairing of the selected cancellation candidate to thereby perform pairing with a device which is a transmission source of a request for pairing instead.

However, in a case where pairing is automatically canceled, there is the possibility that the cancellation of pairing against a user's intention is performed, and thus it is preferable that requirements of automatic cancellation are stricter than requirements for selecting a cancellation candidate. For example, in a case where a client device which is a cancellation candidate satisfies a requirement such as a content not being acquired from the outside of a house for a predetermined period of time (for example, one year) or longer, the cancellation of pairing may be automatically performed.

[Variance Process]

In the above-described embodiment, a description has been given of an example in which the server 1 performs both the transmission of a content and the management of pairing, but the transmission and the management may be performed individual devices. For example, even in a system including a content transmission apparatus that receives a request for a content and transmits a content in response to the request and an information processing apparatus that receives a request for pairing and performs pairing in response to the request, it is possible to realize the same function as that of the server 1. In such a system, a process for determining and presenting a cancellation candidate may be performed by the information processing apparatus or may be performed by the content transmission apparatus.

### Third Embodiment

A control block (particularly, a control unit 2) of a server 1 may be realized by a logic circuit (hardware) which is formed in an integrated circuit (IC) chip or the like, or may be realized by software using a central processing unit (CPU).

In the latter case, the server 1 includes a CPU that executes a command of a program which is software realizing functions, a read only memory (ROM) or a storage device (each referred to as a “recording medium”) in which the above-mentioned program and various pieces of data are recorded so as to be readable by a computer (or a CPU), a random access memory (RAM) that develops the program, and the like. In addition, the computer (or the CPU) reads the program from the recording medium and executes the program, thereby achieving the object of the invention. The recording medium to be used may be a “non-transitory tangible medium” such as a tape, a disc, a card, a semiconductor memory, or a programmable logic circuit. In addition, the program may be supplied to the computer through any transmission medium (a communication network, broadcast waves, or the like) which is capable of transmitting the program. Meanwhile, the invention may be implemented in the form of a data signal, embedded in a carrier wave, in which the program is embodied by electronic transmission.

### Reference Example 1-1

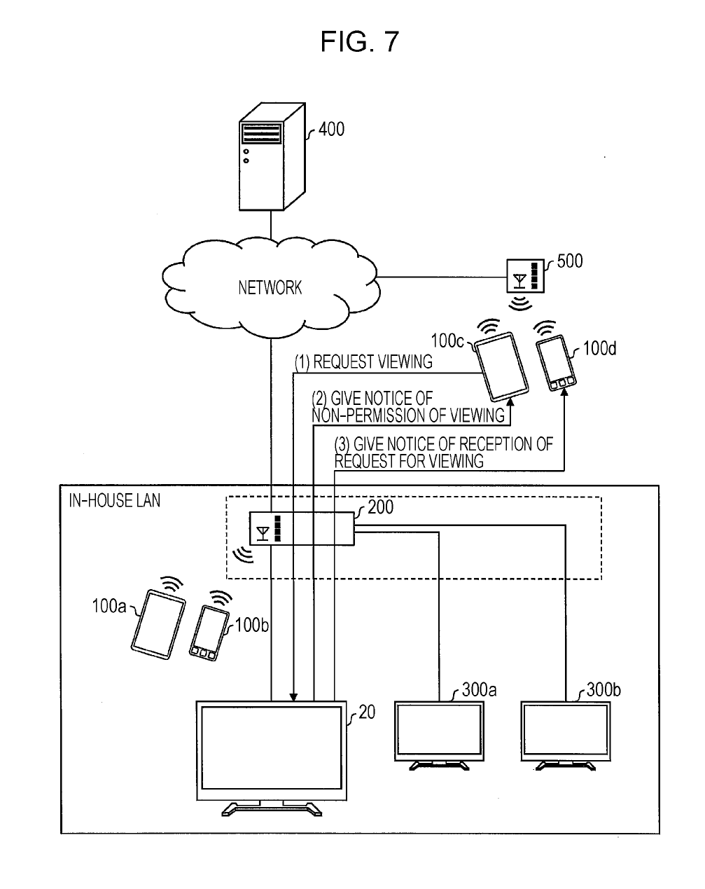

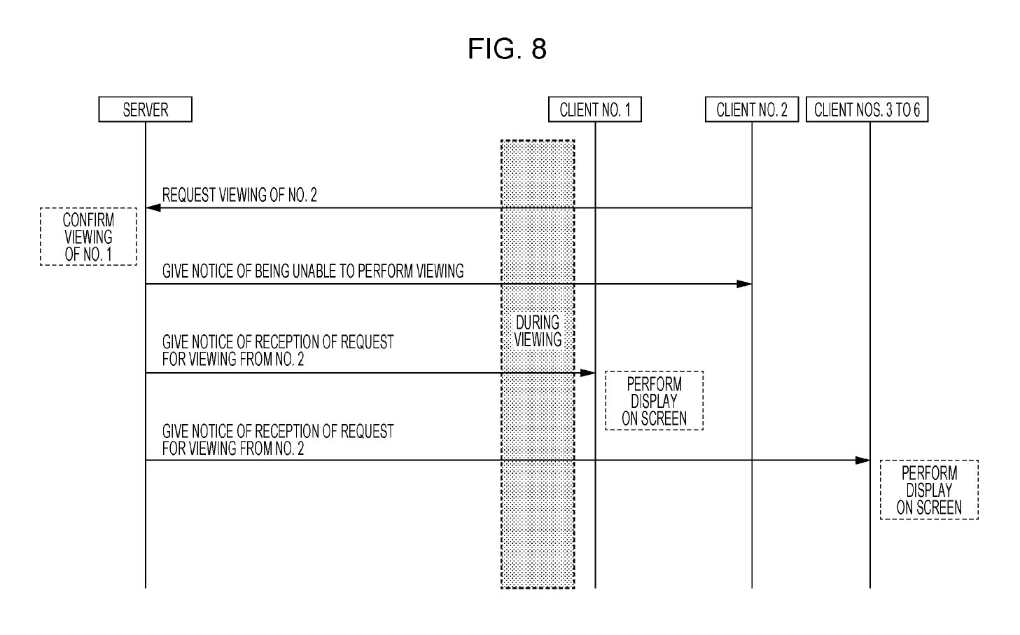

A reference example of the invention will be described with reference to FIGS. 7 and 8. In this reference example, a description will be given of a configuration in which a user of a certain client device can easily recognize that a request for viewing (request for transmission of a content) is made by another client device.

FIG. 7 shows an outline of a content transmission system according to this reference example. Meanwhile, FIG. 7 shows four client devices 100a to 100d, but it is assumed that a server 20 is paired with six client devices including the four client devices. The client device may be a device (slave device) for the exclusive use of the server 20, or may be a general-purpose device such as a mobile phone or a smart phone.

The server 20 according to the reference example 1-1 has the same configuration as that of the server 1 described in the first and second embodiments described above. That is, the server 20 includes a control unit 2, a storage unit 3, a communication unit 4, a display unit 5, an input unit 6, and a content memory 7 (see FIG. 1). However, as described below, the function of the control unit 2 is different from those in the above-described embodiments.

An information processing apparatus (server 20) according to the reference example 1-1 is an information processing apparatus that limits the number of registered devices that simultaneously receive a content in a content transmission system that transmits a content to registered devices (client devices 100a to 100d), which are registered in advance, in response to requests for viewing from the registered devices. A control unit (2) includes a notification unit notifying a registered device receiving a content that a request for viewing of a content is received from another registered device in a case where a request for viewing of a content is received in a state where the number of registered devices simultaneously receiving a content reaches an upper limit.

Hereinafter, the fact that a certain client device receives a content from the server 20 (that is, a user of the client device is viewing a content and a user of another client device is thus not able to view a content) is expressed as the client device having a “viewing right”.

Hitherto, in a case where a request for viewing of a content is received from a second client device when a first client device has a viewing right for a content, a server paired with a plurality of client devices has rejected the request for viewing of the content because the second client device does not have a viewing right.

For this reason, in a case where a user of the second client device desires to immediately view the content, the user needs to find a user of the first client device having a viewing right and to request the user of the first client device to stop viewing a content. In addition, since the user of the first client device cannot recognize that a request for viewing is made by the second client device even when the user considers that the viewing of a content may be stopped in a case where a request for viewing is made by another user, the user of the first client device cannot perform any specific action.

On the other hand, in the content transmission system according to this reference example, a user of a first client device can easily recognize that a request for viewing is made by a second client device. That is, as shown in FIG. 7, in a case where the server 20 receives a request for viewing from the client device 100c at the time of transmitting a content to the client device 100d (1), the notification unit notifies the client device 100c of the non-permission of viewing (2) and notifies the client device 100d of the reception of the request for viewing (3). Thereby, a user of the client device 100d which is receiving a content from the server 20 can easily recognize that a request for viewing is made by another user.

[Sequence of Reference Example 1-1]

A flow of an operation of the content transmission system according to this reference example will be described with reference to FIG. 8. FIG. 8 is a diagram showing a sequence of operations of the server 20 of the content transmission system shown in FIG. 7 and six client devices (including the client devices 100a to 100d).

Here, a description is given of an example in which when one client device 100d (hereinafter, referred to as a client No. 1), among the six client devices paired with the server 20, has a viewing right, a request for viewing is transmitted to the server 20 from another client device 100c (hereinafter, referred to as a client No. 2). In addition, the remaining four client devices will be referred to as client Nos. 3 to 6.

As shown in FIG. 8, first, the client No. 2 transmits a request for viewing to the server 20.

The control unit 2 of the server 20 having received the request for viewing from the client No. 2 notifies the client No. 2 that the viewing of a content is not permitted (because the client No. 1 is viewing a content and the client No. 2 does not have a viewing right).

In addition, the notification unit notifies the client No. 1 having a viewing right of the reception of the request for viewing from the client No. 2. At this time, the notification unit also notifies the client No. 3 of information for specifying the client No. 2 (client information) among the paired six clients.

Here, the client information may be information capable of uniquely identifying a client device, and may be, for example, a model number of the client No. 2. In addition, the client information may include incidental information of the client No. 2 which is registered in the server 20, for example, a user name, age, and sex of the client No. 2, in addition to the model number, and may include a device type name of the client No. 2.

Alternatively, the client information may include identification information (name, title, program code, and the like) of a content requested by the client No. 2 or information (position, whether or not the client is in motion, a remaining amount of a battery) regarding the state of the client No. 2. Further, when the client No. 2 is a 3G mobile phone having a function of giving notice of information indicating a radio wave state, or the like, the client information may include information indicating the radio wave state of the client No. 2.

The client No. 1 displays a message indicating that the server 20 has received a request for viewing of a content from the client No. 2, and client information of the client No. 2 on a screen of the client No. 1. The message and the client information may be displayed so as to be superposed on a content (overlapping display), or may be display in a different from a screen region in which the content is displayed, that is, may be displayed on the same screen in a non-superposition manner.

The user of the client No. 1 having confirmed the message can easily recognize that a request for viewing of a content is made. Further, it is possible to determine whether to stop the viewing of a content on the basis of the client information of the client No. 2.

Meanwhile, the notification unit of the server 20 may also notify the client Nos. 3 to 6 that a request for viewing has been received from the client No. 2. In this configuration, it is possible to expect that users of the client Nos. 3 to 6 recognize that requests for viewing has been already transmitted (requests for viewing are mixed) and prevent the users from uselessly transmitting a request for viewing.

As described above, the server 20 can support the users of the client Nos. 1 to 6 so that the users can smoothly view a content.

### Reference Example 1-2

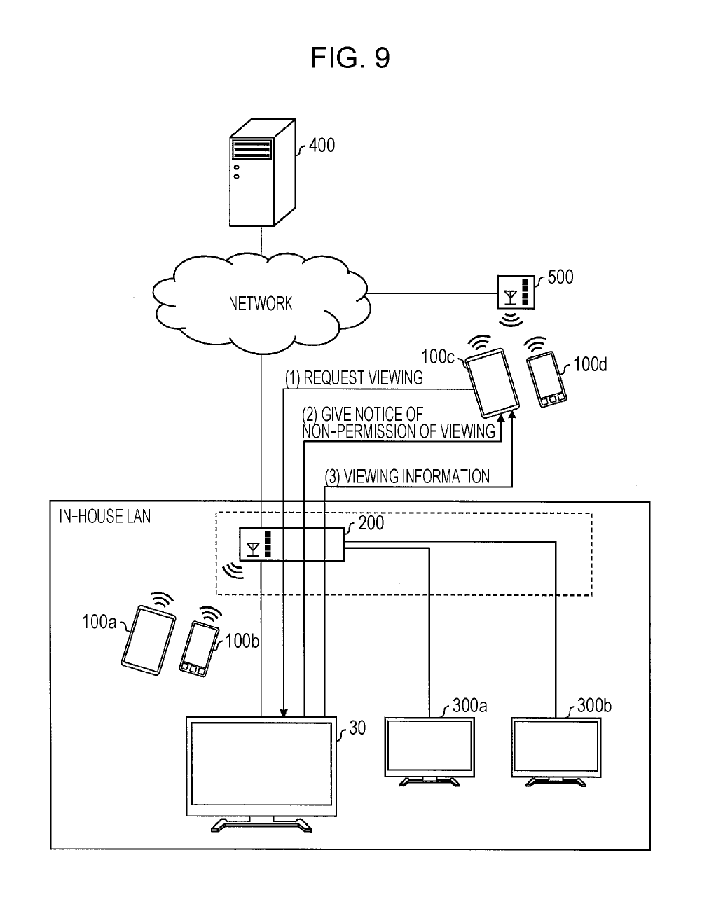

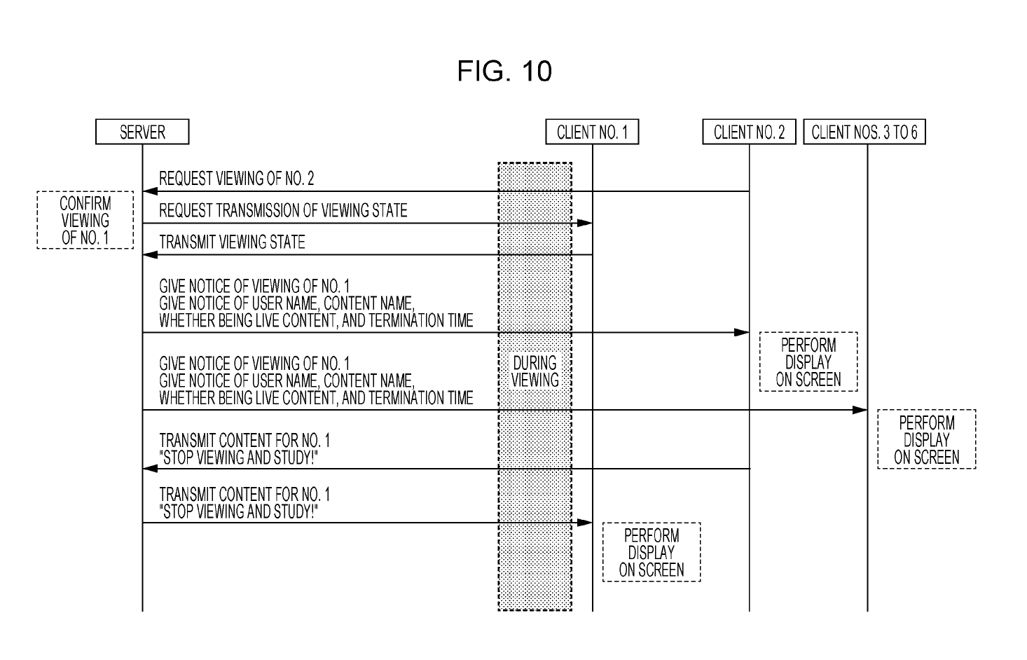

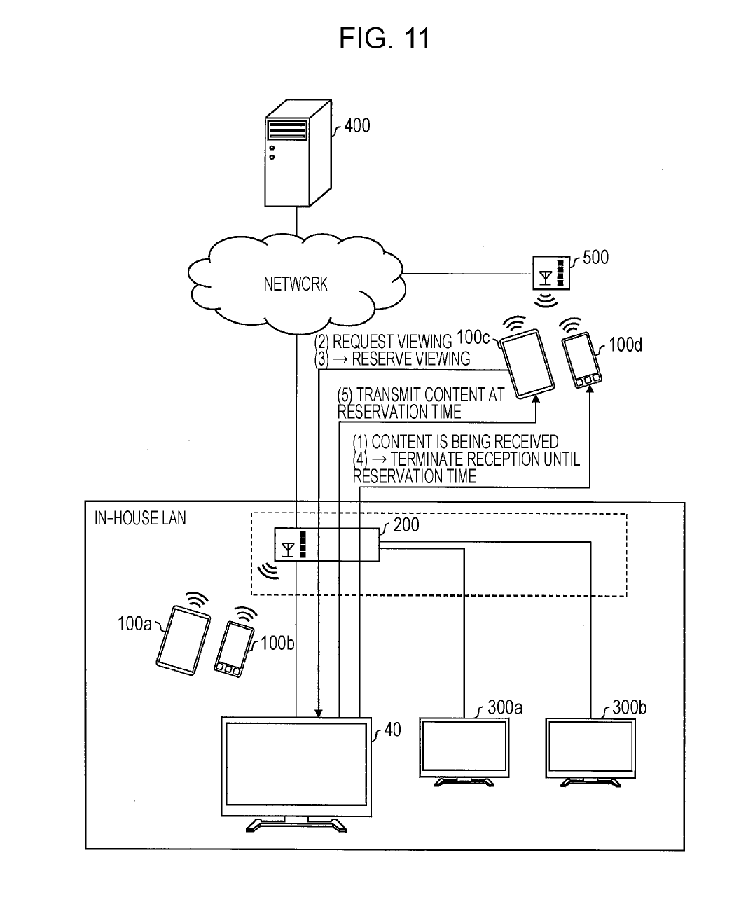

Another reference example of the invention will be described with reference to FIGS. 9 and 10.

FIG. 9 is a diagram showing an outline of a content transmission system according to this reference example. The content transmission system shown in FIG. 9 is different from the content transmission system shown in FIG. 7 in that a server 30 is provided instead of the server 20. The server 30 has the same configuration as that of the server 20, but is different from the server 20 in that a function of a control unit 2 is further added as described below.

In an information processing apparatus (server 30) according to the reference example 1-2, the control unit (2) further includes an information transmission unit that transmits information (viewing information) regarding a registered device, which is receiving a content, to registered devices (client devices 100a to 100d) which are transmission sources of a request for viewing of a content in the information processing apparatus according to the reference example 1-1.

As described in the reference example 1, when the client No. 1 has a viewing right for a content, the server 20 does not permit the client No. 2 viewing a content, and thus a user of the client No. 2 cannot view the content.

At this time, the user of the client No. 2 cannot know the reason the user can view a content is because of a problem of the client No. 2, because of a problem of communication, or because another user is viewing a content.

Consequently, in this reference example, when a request for viewing is received from the client No. 2, the server 30 (information transmission unit of the control unit 2) notifies the client No. 2 that the client No. 1 is viewing a content. That is, as shown in FIG. 9, in a case where the server 30 receives a request for viewing from the client device 100c at the time of transmitting a content to the client device 100d (1), the notification unit notifies the client device 100c of the non-permission of viewing (2), and the information transmission unit gives notices of viewing information (3). Meanwhile, the viewing information is information regarding a content which is viewed by the client device 100d, by a user of the client device 100d, or by the client device 100d. Accordingly, the user of the client device 100c cannot easily recognize a situation in which viewing cannot be performed.

[Sequence of Reference Example 1-2]

A flow of an operation of the content transmission system according to this reference example will be described with reference to FIG. 10. FIG. 10 is a diagram showing a sequence of operations of the server 30 of the content transmission system shown in FIG. 9 and six client devices (including the client devices 100a to 100d).

Similarly to the reference example 1, first, the client No. 1 has a viewing right for a content. In this state, the client No. 2 transmits a request for viewing of a content to the server 30.

As shown in FIG. 10, the notification unit of the server 30 having received a request for viewing from the client No. 2 notifies the client No. 2 that the viewing of a content is not permitted (because the client No. 1 is viewing a content and the client No. 2 does not have a viewing right).

In addition, the information transmission unit of the server 30 notifies the client No. 1 having a viewing right of the reception of a request for viewing from the client No. 2. At this time, the information transmission unit of the server 30 requests the client No. 1 to transmit viewing information indicating a viewing state of the client No. 1. The client No. 1 transmits the viewing information to the server 30 in response to the request.

Here, the viewing information may be information indicating the position of the client No. 1, whether the client is in motion, the orientation (vertical orientation or horizontal orientation) of a screen, a remaining amount of a battery, a radio wave state, and the like. Alternatively, the viewing information may be details (a title, live or recording, a remaining time) of a content which is being viewed, or a user name of the client No. 1.

The information transmission unit of the server 30 transmits viewing information of the client No. 1 to the client No. 2. Further, the information transmission unit of the server 30 also transmits incidental information of the client No. 1 to the client No. 2, in addition to the viewing information of the client No. 1. The wording “incidental information” as used herein may be a user name, age, and sex of the client No. 1, or may be a device type name of the client No. 1. Further, the information transmission unit of the server 30 may transmit a viewing time of a content or a cumulative viewing time in the client No. 1 to the client No. 2. In addition, the client No. 2 displays the received viewing information and incidental information.

Meanwhile, the information transmission unit of the server 30 notifies not only the client No. 2 but also the client Nos. 3 to 6 of viewing information and incidental information. Thereby, users of the client Nos. 3 to 6 can also know a viewing state of a content in the client No. 1.

In addition, the user of the client No. 2 may transmit a comment for the user of the client No. 1 to the server 30. In addition, the information transmission unit of the server 30 may transmit the comment received from the client No. 2 to the client No. 1.

According to the above-described configuration, the user of the client No. 2 can determine whether to make the user of the client No. 1 stop viewing a content, on the basis of the viewing information and the incidental information of the client No. 1 which are received from the server 30. In addition, it is possible to prompt the user of the client No. 1 to stop viewing a content by transmitting a comment to the user.

### Reference Example 1-3

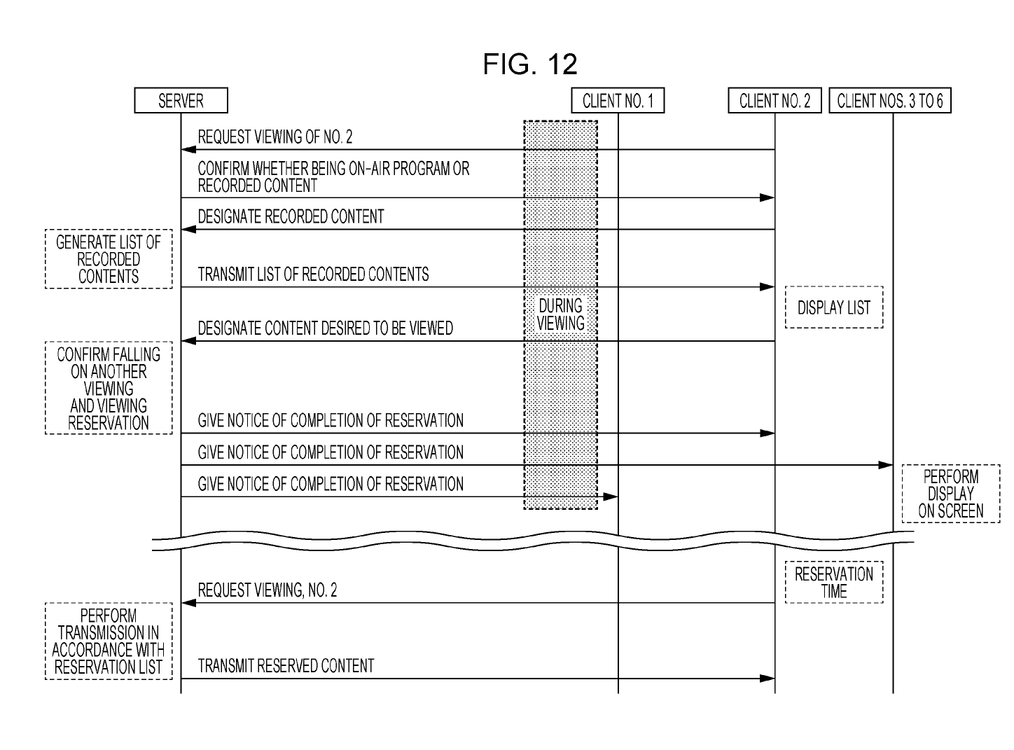

Another reference example of the invention will be described with reference to FIGS. 11 and 12.

FIG. 11 is a diagram showing an outline of a content transmission system according to this reference example. The content transmission system shown in FIG. 11 is different from the content transmission system shown in FIG. 7 in that a server 40 is provided instead of the server 20. The server 40 has the same configuration as that of the server 20, but is different from the server 20 in that a function of a control unit 2 is further added as described below.

In an information processing apparatus (server 40) according to the reference example 1-3, the control unit (2) includes a reservation unit that makes a registered device, having transmitted a request for viewing of a content, receive a content after a time when the reception of a content is terminated by a registered device receiving a content is terminated, in a case where the request for viewing of the content is received in a state where the number of registered devices simultaneously receiving a content reaches an upper limit in the information processing apparatus according to the reference example 1-1.

As described in the reference example 1-1, the client No. 2 cannot obtain a viewing right for a content until the viewing of a content in the client No. 1 is terminated. In addition, in a case where the viewing of a content in other client Nos. 3 to 6 is started after the viewing in the client No. 1 is terminated, the user of the client No. 2 needs to further wait until the viewing of a content in other client Nos. 3 to 6 is terminated. For this reason, there is the possibility that the user of the client No. 2 cannot know from when the user can view a content.

Consequently, in this reference example, a description will be given of an example in which the reservation unit of the server 40 receives a reservation for viewing of a content from the client No. 2. That is, as shown in FIG. 11, in a case where a request for viewing is received from the client device 100c (2) when the server 40 transmits a content to the client device 100d (1), the client device 100c having not obtained the permission of viewing makes a reservation for viewing with respect to the server 40 (3). The reservation unit of the server 40 receives the reservation for viewing. In addition, in the client device 100d, the reception of a content is terminated until a reservation time (4), and a content reserved in the client device 100c by the reservation unit of the server 40 is transmitted at the reservation time. Accordingly, the user of the client device 100c can promptly start viewing a desired content after the viewing in the client device 100d is terminated.

[Sequence of Reference Example 1-3]

A flow of an operation of the content transmission system according to this reference example will be described with reference to FIG. 12. FIG. 12 is a diagram showing a sequence of operations of the server 40 of the content transmission system shown in FIG. 11 and six client devices (including the client devices 100a to 100d).

Here, a description is given of an example in which when one client device 100d (hereinafter, referred to as a client No. 1), among the six client devices paired with the server 40, has a viewing right, a request for viewing is transmitted to the server 40 from another client device 100c (hereinafter, referred to as a client No. 2). In addition, the remaining four client devices will be referred to as client Nos. 3 to 6.

As shown in FIG. 12, the reservation unit of the server 40 having received the request for viewing from the client No. 2 inquires of the client No. 2 whether a content that the client desires to view is a live content (television program being broadcasted) or a recorded content (content recorded in a recorder or the like).

The client No. 2 notifies the server 40 which one of a recorded content or a live content is designated, in response to the inquiry received from the server 40. Here, the client notifies the server 40 of the designation of a recorded content. Meanwhile, a live content cannot be viewed after broadcasting is terminated, and thus is not set as a target for reservation.

The reservation unit of the server 40 generates a list of recorded contents in response to the notification indicating the designation of a recorded content which is received from the client No. 2, and transmits the generated list of recorded contents to the client No. 2.

The client No. 2 displays the list of recorded contents which is received from the server 40. A user of the client No. 2 designates a content to be viewed, in the displayed list of recorded contents. The client No. 2 notifies the server 40 of the content designated by the user.

The reservation unit of the server 40 secures a time slot corresponding to the length of the content designated by the client No. 2 after a viewing time of a content based on the client No. 1 (a time after a viewing termination time), as a time (reservation time) when the viewing of a content in the client No. 2 is permitted. In addition, the client No. 2 is given notice of a reservation time of the viewing of a content.

Meanwhile, in a case where the viewing of a content based on another client has been already reserved after the viewing time of the content based on the client No. 1, the reservation unit of the server 40 determines a reservation time of the viewing of a content based on the client No. 2 so as to prevent batting with the viewing time of the content based on the client No. 1 and the reservation time of the viewing of a content based on the client No. 2.

In addition, the reservation unit of the server 40 notifies the client Nos. 1 and 3 to 6 of a viewing time of a content in the client No. 2. The client Nos. 1 and 3 to 6 display the reservation time of the viewing of a content in the client No. 2 which is given notice of by the server 40. Thereby, the users of the client Nos. 1 and 3 to 6 can know the viewing time of a content in the client No. 2.

When a reservation time of the viewing of a content arrives, the client No. 2 transmits a request for viewing of the content to the server 40. In addition, the reservation unit of the server 40 transmits a reserved content to the client No. 2. The client No. 2 outputs a content received from the server 40.

### Reference Example 1-4

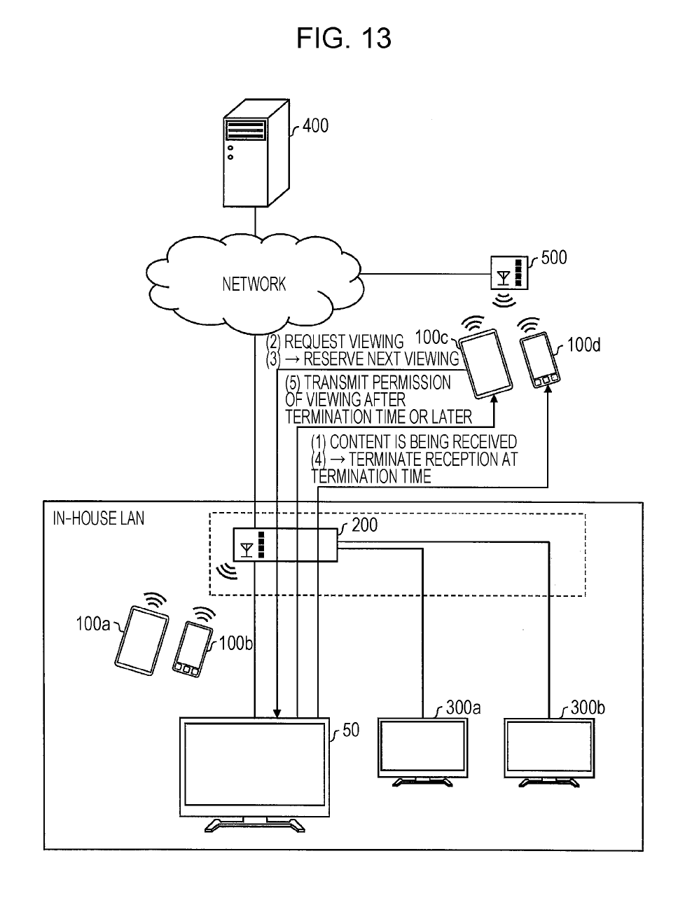

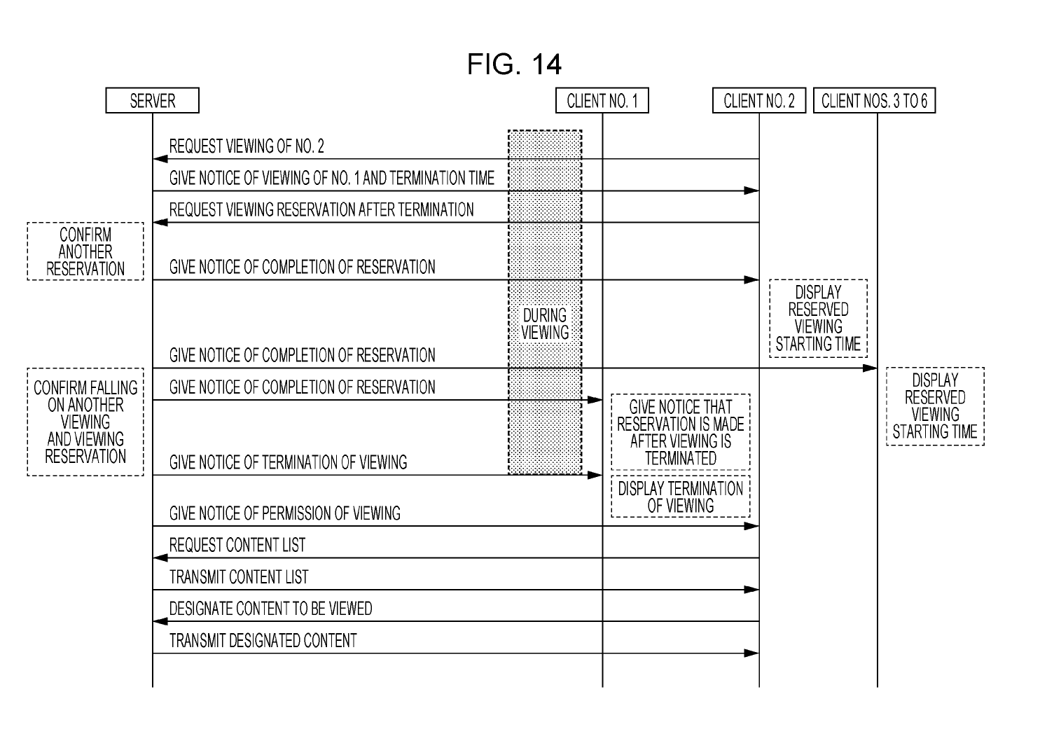

Another reference example of the invention will be described with reference to FIGS. 13 and 14.

FIG. 13 is a diagram showing an outline of a content transmission system according to this reference example. The content transmission system shown in FIG. 13 is different from the content transmission system shown in FIG. 11 in that a server 50 is provided instead of the server 40. The server 50 has the same configuration as that of the server 20, but is different from the server 20 in that a function of a control unit 2 is further added as described below.

In an information processing apparatus (server 50) according to the reference example 1-4, the control unit (2) further includes a time notification unit that notifies a registered device (client devices 100a to 100d) which is a transmission source of a request for viewing of a time when a content can be received by the registered device in the information processing apparatus according to the reference example 1-1. In addition, the control unit 2 of the server 50 also includes the reservation unit of the above-described reference example.

In the reference example 1-3, a description has been given of an example in which when the client No. 2 notifies the server 40 of a content to be viewed, the server 40 secures a reservation time of viewing based on the client No. 2 so as to prevent overlapping with a viewing time of a content based on the client No. 1.

On the other hand, in this reference example, the time notification unit of the server 50 having received a request for viewing of a content from the client No. 2 notifies the client No. 2 of a time when the viewing of a content in the client No. 1 is terminated. In addition, a user of the client No. 2 reserves the viewing of a content after a time when the viewing of a content in the client No. 1 is terminated. For this reason, the user of the client No. 2 can reliably view a content at the time reserved by the user himself or herself.

In addition, in the example of FIG. 13, in a case where a request for viewing is received from a client device 100c (2) when the server 50 transmits a content to a client device 100d (1), the client device 100c having not obtained the permission of viewing makes a reservation for viewing subsequent to the viewing of the current content which is performed by the client device 100d, with respect to the server 50 (3). In addition, in the client device 100d, the reception of a content is terminated until a reservation time (4), and the permission of viewing is transmitted to the client device 100c from the server 50 after the reservation time (5). Thereby, the user of the client device 100c can promptly start viewing a desired content after the user of the client device 100d.

[Sequence of Reference Example 1-4]

A flow of an operation of a content transmission system according to this reference example will be described with reference to FIG. 14. FIG. 14 is a diagram showing a sequence of operations of the server 50 of the content transmission system shown in FIG. 13 and six client devices (including the client devices 100a to 100d).

Here, a case is considered in which when one client device 100d (hereinafter, referred to as a client No. 1), among the six client devices paired with the server 50, has a viewing right, a request for viewing is transmitted to the server 50 from another client device 100c (hereinafter, referred to as a client No. 2). In addition, the remaining four client devices will be referred to as client Nos. 3 to 6.

As shown in FIG. 14, a time notification unit of the server 50 having received a request for viewing from the client No. 2 notifies the client No. 2 that a content is viewed by the client No. 1, and notifies the client No. 2 of a time when the viewing of a content in the client No. 1 is terminated. Meanwhile, a time when the notification is given may be a time capable of making a user recognize a timing when a content can be received, and is not limited to a viewing termination time.

The client No. 2 displays a time when the viewing of a content in the client No. 1 is terminated, which is given notice of by the server 50.

A user of the client No. 2 confirms a time when the viewing of a content in the client No. 1 is terminated, to thereby determine a reservation time (viewing starting time) when a content is viewed in a time slot after the time. The client No. 2 notifies the server 50 of the reservation time determined by the user. Meanwhile, the viewing to be performed after the client No. 1 may be simply requested without designating a time.

A reservation unit of the server 50 confirms whether or not the viewing of a content based on another client has been already reserved after a viewing time of a content based on the client No. 1 when a reservation time is given of by the client No. 2. In a case where the viewing of a content based on another client has been already reserved after the viewing time of the content based on the client No. 1, the reservation unit of the server 50 confirms whether or not the reservation time determined by the user of the client No. 2 falls not only on the viewing time of a content based on the client No. 1 but also on a reservation time of viewing of a content based on another client.

In a case where the reservation time determined by the user of the client No. 2 does not overlap the viewing time of a content based on the client No. 1 and the reservation time of viewing of a content based on another client, the reservation unit of the server 50 notifies the client No. 2 that the reception of a reservation has been completed.

The reservation unit of the server 50 notifies the client Nos. 3 to 6 of a time when the viewing of a content based on the client No. 2 is started. In addition, the reservation unit of the server 50 notifies the client No. 1 that the viewing of a content based on the client No. 2 has been reserved after the viewing of a content based on the client No. 1 is terminated.

When a period of time for which the client No. 1 is permitted to view a content is terminated, the reservation unit of the server 50 notifies the client No. 1 of the termination of a period of time for which a content can be received. The client No. 1 that has been notified by the server 50 displays the termination of a period of time for which a content can be received, on a screen of the client No. 1.

Next, the reservation unit of the server 50 notifies the client No. 2 that the viewing of a content is permitted.

The client No. 2 having been notified by the server 50 requests a content list (at least one of a list of live contents and a list of recorded contents) from the server 50.

The reservation unit of the server 50 having received a request from the client No. 2 transmits the requested content list to the client No. 2.

The client No. 2 displays the content list received from the server 50. A user of the client No. 2 designates (lists up, selects, and determines) a content to be viewed in the displayed content list. The client No. 2 notifies the server 50 of the content designated by the user.

The reservation unit of the server 50 transmits the content designated by the user of the client No. 2 to the client No. 2. The client No. 2 outputs a content received from the server 50.

Meanwhile, in the above-described example, a content is designated after the viewing of a content in the client No. 1 is terminated, but a content may be received at the previous timing.

### Reference Example 1-5

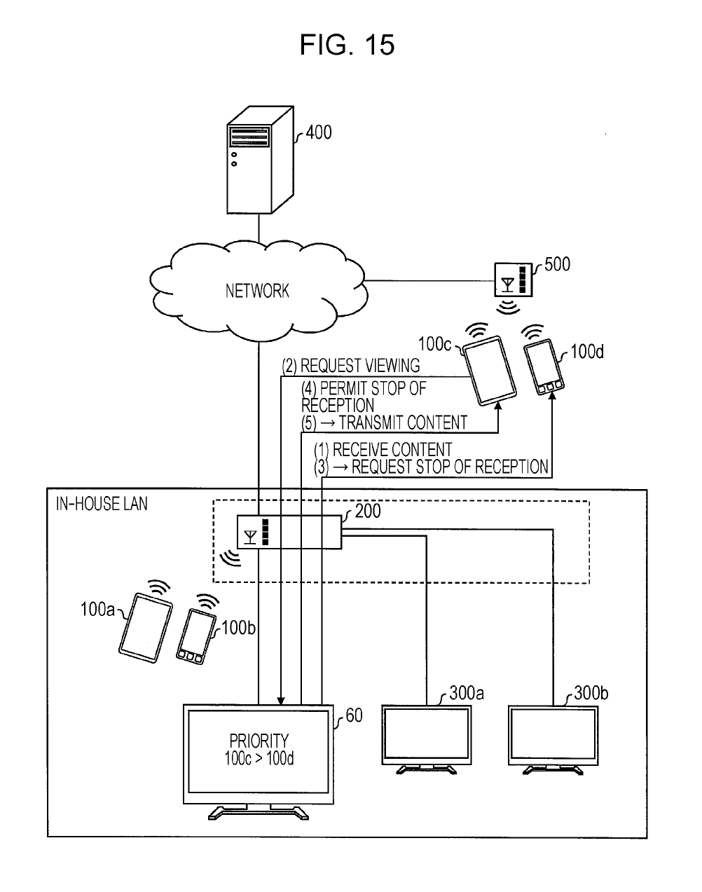

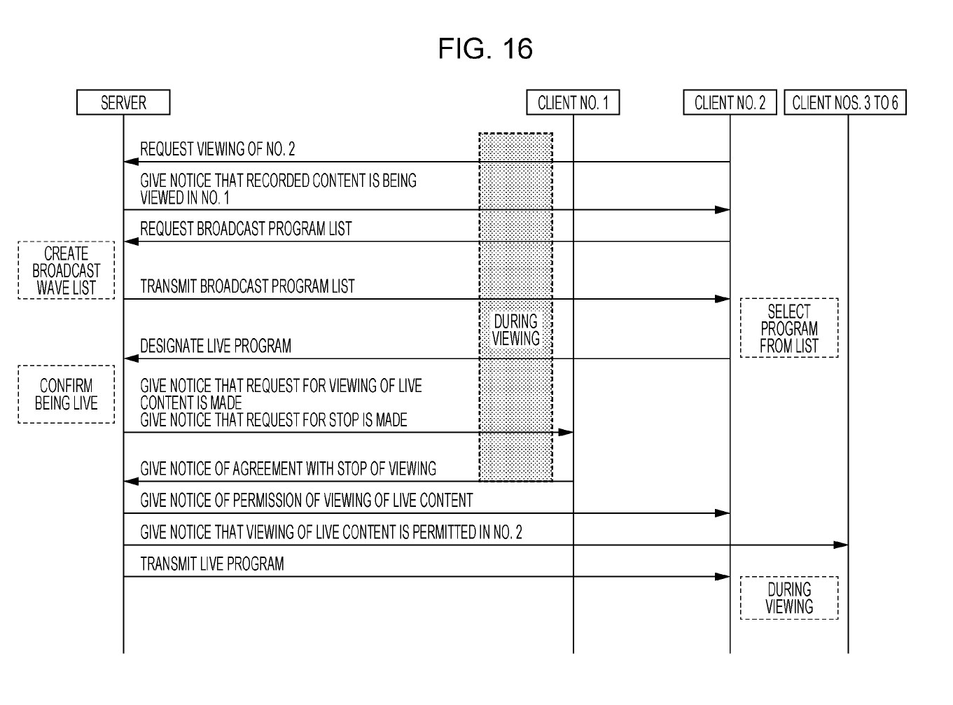

Another reference example of the invention will be described with reference to FIGS. 15 and 16.

FIG. 15 shows an outline of a content transmission system according to this reference example. The content transmission system shown in FIG. 15 is different from the content transmission system shown in FIG. 7 in that a server 60 is provided instead of the server 20. The server 60 as the same configuration as that of the server 20, but is different from the server 20 in that a function of a control unit 2 is further added as described below.

When a content is received by another registered device having a priority lower than that of a registered device having received a request for viewing of a content in a case where the request for viewing is received in a state where the number of registered devices simultaneously receiving a content reaches an upper limit in the information processing apparatus according to the reference example 1-1, or a content having a priority lower than that of a content according to the request for viewing is received by another registered device, an information processing apparatus (server 60) according to the reference example 1-5 further includes a priority control unit that transmits a content to the registered device to which a request for viewing is transmitted, instead of the other registered device.

Here, a description will be given of a case where a user (first user) of a certain client views a recorded content and a user (second user) of another client desires to view a live content. In this case, the second user feels that priority has to be given to the viewing of the live content that the user can only view now. In addition, there is also a user who considers that parents have to view a content in preference to a child.

Consequently, in this reference example, a description will be given of an example in which a client device having a viewing right for a content is smoothly switched on the basis of various orders of priority.

For example, an order of priority related to a viewing right for a content is given to a client device paired with the server 60 in advance. In a case where the priority control unit of the server 60 receives a request for viewing from a client device having an order of priority higher than that of a client device having a viewing right for a content, the priority control unit notifies a client having a viewing right for a content that the request for viewing has been received from the client device having a high order of priority. In addition, a viewing right for a content is switched to a client device having a high order of priority.

On the other hand, in a case where the server 60 receives a request for viewing from a client having an order of priority lower than that of a client device having a viewing right for a content, the server notifies the client device having a viewing right for a content that the request for viewing has been received from another client device. However, the viewing right is not switched.

Meanwhile, an order of priority of a client is not limited to an order of priority related to a viewing right. For example, priority may be given to a client device desiring to view a live content over a client device desiring to view a recorded content. In this configuration, in a case where a request for viewing of a live content is received from another client device while a recorded content is viewed by a certain client device, the server 60 shifts a viewing right to the another client device.

In the example of FIG. 15, in a case where a request for viewing is received from a client device 100c (2) when the server 60 transmits a content to a client device 100d (1), the priority control unit of the server 60 requests the client device 100d having a low priority to stop the reception of a content in a case where the client device 100c has a higher priority than the client device 100d (3). In addition, in a case where the client device 100d response to the request, the priority control unit of the server 60 starts to transmit a content to the client device 100c (5). Thereby, a user of the client device 100c can promptly start to view a desired content.

[Sequence of Reference Example 1-5]

A flow of an operation of the content transmission system according to this reference example will be described with reference to FIG. 16. FIG. 16 is a diagram showing a sequence of operations of the server 60 of the content transmission system shown in FIG. 15 and six client devices (including the client devices 100a to 100d).

Here, a description is given of an example in which when one client device 100d (hereinafter, referred to as a client No. 1), among the six client devices paired with the server 60, has a viewing right, a request for viewing is transmitted to the server 60 from another client device 100c (hereinafter, referred to as a client No. 2). In addition, the remaining four client devices will be referred to as client Nos. 3 to 6. In addition, in the following description, it is assumed that a recorded content is viewed by the client No. 1.

As shown in FIG. 16, first, the client No. 2 transmits a request for viewing to the server 60. The priority control unit of the server 60 having received the request for viewing from the client No. 2 notifies the client No. 2 that a content is being viewed by the client No. 1.

The client No. 2 having been notified by the server 60 requests a broadcast program list (a list of recorded broadcast programs and a live content list which is a list of programs being broadcasted) from the server 60.

The priority control unit of the server 60 transmits the broadcast program list to the client No. 2 in response to the request received from the client No. 2. The client No. 2 displays the broadcast program list received from the server 60.

A user of the client No. 2 designates any program from the broadcast program list. Here, it is assumed that a live program is designated. The client No. 2 notifies the server 60 of the live program designated by the user.

The priority control unit of the server 60 confirms that a program given notice of by the client No. 2 is not a recorded program but a live program to thereby notify the client No. 1 of the reception of a request for viewing of a live program and to request the client No. 1 to stop viewing a recorded content (to resign a viewing right). In other words, in this example, the priority control unit of the server 60 determines that the client No. 2 requesting a live content has a priority higher than that of the client No. 1 receiving a recorded content.

The client No. 1 displays a message to the effect that the server 60 has received a request for viewing of a live program and a message to the effect that the server desires to view a recorded content. The user of the client No. 1 confirms the display and stops viewing the recorded content. The client No. 1 notifies the server 60 of the understanding of resignation of a viewing right.

The priority control unit of the server 60 receives a notification indicating the understanding of resignation of a viewing right from the client No. 1 and then notifies the client No. 2 that the viewing of a live program is permitted (a viewing right is given). In addition, the priority control unit of the server 60 notifies the client Nos. 3 to 6 that the client No. 2 is given a viewing right.

The priority control unit of the server 60 transmits the content of the live program which is designated by the user of the client No. 2 to the client No. 2.

[Implementation Example Based on Software]

The units (the notification unit, the information transmission unit, the reservation unit, the time notification unit, and the priority control unit) of the control units 2 of the respective servers 20 to 60 according to the reference examples 1-1 to 1-5 may be realized by a logic circuit (hardware) which is formed in an integrated circuit (IC) chip or the like, or may be realized by software using a central processing unit (CPU).

In the latter case, the servers 20 to 60 include a CPU that executes a command of a program which is software realizing functions, a read only memory (ROM) or a storage device (each referred to as a “recording medium”) in which the above-mentioned program and various pieces of data are recorded so as to be readable by a computer (or a CPU), a random access memory (RAM) that develops the program, and the like. In addition, the computer (or the CPU) reads the program from the recording medium and executes the program, thereby achieving the object of the invention according to each of the reference examples 1-1 to 1-5. The recording medium to be used may be a “non-transitory tangible medium” such as a tape, a disc, a card, a semiconductor memory, or a programmable logic circuit. In addition, the program may be supplied to the computer through any transmission medium (a communication network, broadcast waves, or the like) which is capable of transmitting the program. Meanwhile, the invention according to each of the reference examples 1-1 to 1-5 may be implemented in the form of a data signal, embedded in a carrier wave, in which the program is embodied by electronic transmission.

### Reference Example 2-1

Hitherto, a portable terminal (client device) configured in accordance with a guideline of digital living network alliance (DLNA: registered trademark) can be used to view an image of a television (server) configured in accordance with the same guideline in a house. A server transmits a content in a wireless manner, and a client device receives a content in various places of a house. In addition, a technique for allowing a client device paired with a server to receive a content from the server outside a house has also been developed.

In a case where a client device outside a house can be connected to a server indefinitely, that is, in a case where a user can view a content indefinitely outside a house, there is the possibility that a content is illegally viewed by a device other than a client device. Consequently, it is proposed that a period of time for which pairing is valid, that is, a pairing validity term which is a time limit by which a client device can be connected to a server is set in the client device.

However, in a case where a pairing validity term is set, a user of the client device does not necessarily ascertain the pairing validity term. A user who does not a pairing validity term feels like that the user cannot suddenly view a content at a point of time passing the pairing validity term. Consequently, it is considered that the server notifies the client device of the approach of the pairing validity term.

Here, in a case where a client device is receiving a content or an application program for viewing a content (hereinafter, referred to as an application for viewing) is in operation in a client device, a server can relatively simply transmit a warning message to the client device by taking the warning message on communication between the client device and the application for viewing.

On the other hand, in a case where the client device is in a stopped state or an application for viewing is in a stopped state, the client device and the server cannot directly communicate with each other, which results in a problem that the client device cannot receive the warning message from the server. For this reason, the client device requires a technique for giving a notice of a pairing validity term using a method other than communication. This reference example is for the purpose of solving this problem.

That is, in this reference example, a description will be given of a method in which in a case where the server 20 cannot communicate with the client devices 100a to 100d (see FIG. 2) having an approaching pairing validity term, the server 20 notifies users of the client devices 100a to 100d of a warning message indicating that the following pairing validity term is approaching. Specifically, in a case where the client devices 100a to 100d are in a stopped state at a point of time when a period of time until the following pairing validity terms of the client devices 100a to 100d is set to be a predetermined period of time, the server 20 displays a warning message on a screen on the server side.

Meanwhile, the server 20 according to the reference example 2-1 has the same configuration as that of the server 1 described in the first and second embodiments described above. That is, the server 20 includes a control unit 2, a storage unit 3, a communication unit 4, a display unit 5, an input unit 6, and a content memory 7 (see FIG. 1). However, the function of the control unit 2 is different from those in the above-described embodiments as described below.

The information processing apparatus (server 20) according to the reference example 2-1 is an information processing apparatus that manages the registration of registered devices (client devices 100a to 100d), which are registered in advance, in a content transmission system that transmits a content to the registered devices in accordance with requests for viewing which are received from the registered devices. The control unit (2) includes a notification unit that notifies a user of the registered device that a period of time until a validity term (pairing validity term) of registration of the registered device is set to be a predetermined period of time.

More specifically, in a case where it is not possible to perform communication with a registered device in which a period of time until a validity term of registration is set to be a predetermined period of time, the notification unit gives a notice by the information processing apparatus. Thereby, even when communication with a registered device cannot be performed, it is possible to make a user of the registered device recognize that a period of time until a validity term of registration is set to be a predetermined period of time.

[Sequence of this Reference Example 2-1]

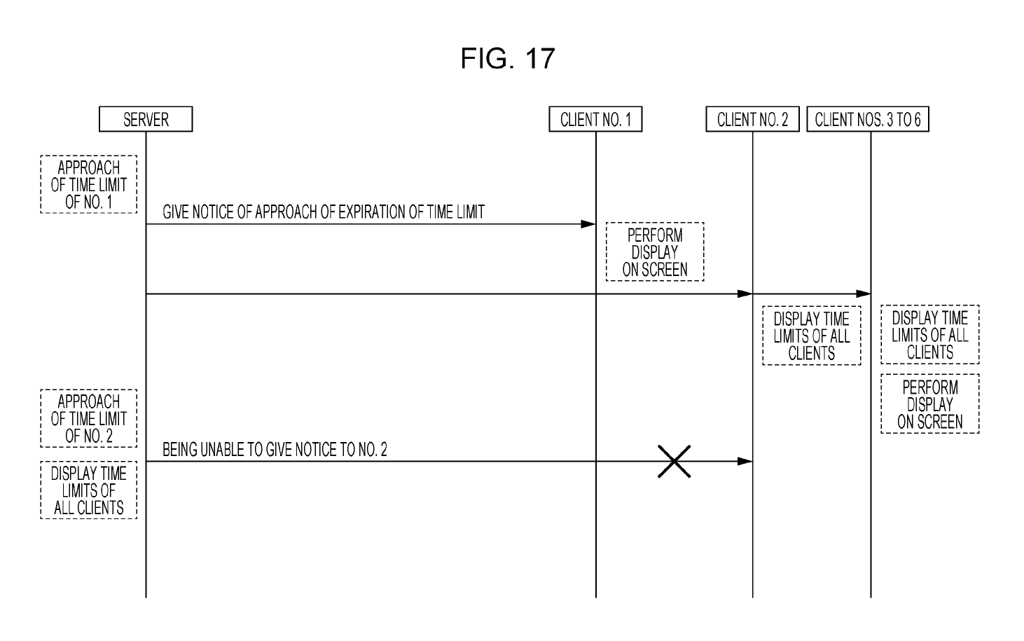

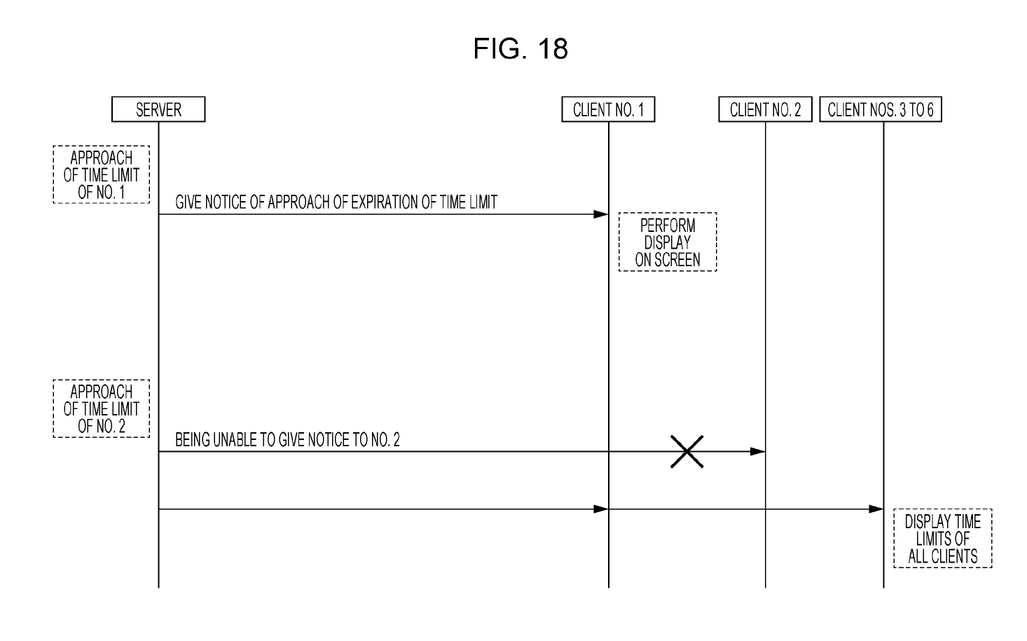

A flow of an operation of the content transmission system according to this reference example will be described with reference to FIG. 17. FIG. 17 is a diagram showing a sequence of operations of the server 20 of the content transmission system according to this reference example and six client devices (including the client devices 100a to 100d).

Here, one client device 100d among the six client devices paired with the server 20 will be referred to as a client No. 1, and another client device 100c will be referred to as a client No. 2. In addition, the remaining four client devices will be referred to as client Nos. 3 to 6.

As shown in FIG. 17, when a period of time until a connection validity term of the client No. 1 is set to be a predetermined period of time, the notification unit of the server 20 attempts to transmit a warning message to the client No. 1. Here, it is assumed that the client No. 1 can receive a warning message from the server 20.

The notification unit of the server 20 transmits a warning message to the client No. 1. The client No. 1 having received the warning message from the server 20 displays the received warning message. At this time, the client No. 1 may display the warning message so as to be superposed on a content being displayed in a case where the content is being displayed, or may display the warning message in the vicinity of the content being displayed in a conspicuous manner.

More specifically, in a case where a content is being viewed in the client No. 1 or in a case where an application for viewing is mainly in operation (that is, in a case where a content is being viewed by the application for viewing), the client No. 1 displays the warning message so as to be superposed on a content being displayed. Alternatively, the warning message may be displayed in the vicinity of the content being displayed in a conspicuous manner.

On the other hand, in a case where a content is not being viewed in the client No. 1, the client No. 1 displays specific contents (the date and time of a pairing validity term, a reconnection (re-pairing) method, and a message indicating that reconnection can be performed only in a house) on a dialogue. In addition, in a case where an application for viewing is a resident type and does not operate mainly, the client No. 1 may awaken a user's attention by displaying an icon for warning the approach of the pairing validity term, or the like.

Next, the notification unit of the server 20 notifies a client device capable of communicating with the server 20 among the client Nos. 2 to 6 of connection validity terms of all of the client Nos. 1 to 6. The client device having been notified by the server 20 displays the connection validity terms of all of the client Nos. 1 to 6.

Thereafter, when a period of time until a pairing validity term of the client No. 2 is set to be a predetermined period of time, the notification unit of the server 20 attempts to transmit a warning message to the client No. 2. Here, it is assumed that the client No. 2 is not in a start-up state (that is, is in a stopped state) and is thus not capable of receiving the warning message from the server 20.

Since a warning message cannot be transmitted to the client No. 2, the notification unit of the server 20 displays a warning message indicating that a period of time until a pairing validity term of the client No. 2 is set to be a predetermined period of time, on a screen (display unit 5) of the server 20. For example, in a case where the server 20 is a television, the server 20 may display a warning message so as to be superposed on a display screen of the television.

The notification unit of the server 20 may display a simple icon, or may display a simple message (wording) such as “there is a client having a pairing validity term almost expired”. In addition, a date and time of a pairing validity term, a model number of a client, a user name, and the like may be displayed. In addition, these may be displayed in a stepwise manner. In this configuration, when the notification unit of the server 20 displays an icon and receives an operation for designating the icon, the notification unit displays a simple message. Further, when the notification unit receives an operation for designating the message, the notification unit displays a detailed description regarding a pairing validity term.

Meanwhile, the notification unit of the server 20 may display a warning message at a point of time (timing) when a power supply is supplied to the server 20, or a warning message may be displayed at all times since a point of time when the remaining period of time of the client No. 2 is set to be a predetermined period of time. Alternatively, a warning message may be displayed on a regular basis.

A user (a viewer of a television in a case where the server 20 is a television) who has confirmed a warning message displayed on a screen on the server 20 side can recognize that a pairing validity term of the client No. 2 is approaching. Thereby, the user can update the pairing of the client No. 2 for himself or herself or can prompt the user of the client No. 2 to perform pairing. In this manner, the server 20 can prevent the pairing validity term of the client No. 2 from expiring.

### Reference Example 2-2

In the reference example 2-1 described above, a description has been given of a configuration in which a warning message is displayed on the screen of the server 20 in a case where the server 20 cannot communicate with the client devices 100a to 100d having an approaching pairing validity term.

In this reference example, the notification unit of the server 20 transmits a warning message to other communicable client devices 100a to 100d in a case where communication with the client devices 100a to 100d having an approaching pairing validity term.

In many cases, users of client devices paired with the same server 20 are family members, and thus there is a strong possibility that a user of a certain client device is present in the vicinity of a user of another client device. For this reason, a user of a client device having an approaching pairing validity term can have another user having a client device paired with the same server 20 teach that the pairing validity term of his or her own client device is approaching.

In other words, the notification unit according to the reference example 2-2 gives notice to another registered device in a case where it is not possible to perform communication with a registered device in which a period of time until a validity term of registration is set to be a predetermined period of time. Thereby, even when communication with a registered device cannot be performed, it is possible to make a user of the registered device recognize that a period of time until a validity term of registration is set to be a predetermined period of time.

[Sequence of Reference Example 2-2]

A flow of an operation of the content transmission system according to this reference example will be described with reference to FIG. 18. FIG. 18 is a diagram showing a sequence of operations of the server 20 of the content transmission system according to this reference example and six client devices (including the client devices 100a to 100d).

Here, one client device 100d among the six client devices paired with the server 20 will be referred to as a client No. 1, and another client device 100c will be referred to as a client No. 2. In addition, the remaining four client devices will be referred to as client Nos. 3 to 6.

As shown in FIG. 18, when a period of time until a pairing validity term of the client No. 1 is set to be a predetermined period of time, the notification unit of the server 20 attempts to transmit a warning message to the client No. 1. Here, it is assumed that the client No. 1 can receive a warning message from the server 20.

The notification unit of the server 20 transmits a warning message to the client No. 1. The client No. 1 displays the warning message received from the server 20. The details thereof have been described in the reference example 2-1 described above, and thus a description thereof will not be iterated.

Thereafter, when a period of time until a pairing validity term of the client No. 2 is set to be a predetermined period of time, the notification unit of the server 20 attempts to transmit a warning message to the client No. 2. Here, it is assumed that the client No. 2 cannot receive the warning message from the server 20 due to not being in a start-up state.

Since a warning message cannot be transmitted to the client No. 2, the notification unit of the server 20 transmits a warning message indicating that a pairing validity term of the client No. 2 is approaching, to a client device capable of communicating with the server 20 among the other client Nos. 1 and 3 to 6.

At this time, the notification unit of the server 20 may transmit at least one of an icon, a simple message, and detailed information of the client No. 2 to the client Nos. 1 and 3 to 6, in addition to the warning message.

In addition, the notification unit of the server 20 also notifies the client Nos. 1 and 3 to 6 of pairing validity terms of the client Nos. 1 and 3 to 6 or the remaining period of times until the pairing validity terms thereof. The client Nos. 1 and 3 to 6 display the pairing validity terms or the remaining period of times until the pairing validity terms which are given notice of by the server 20. For this reason, users of the client Nos. 1 and 3 to 6 can know not only the approach of a pairing validity term of the client 2 but also information regarding pairing validity terms of the clients themselves.

### Reference Example 2-3

In this reference example, a notification unit of a server 20 notifies client devices 100a to 100d that a pairing validity term almost expires, when an application for viewing is started up in the client devices 100a to 100d or when the client devices 100a to 100d and the server 20 can communicate with each other in a case where communication with the client devices 100a to 100d having an approaching pairing validity term cannot be performed.

In other words, the notification unit according to the reference example 2-3 stands by until it is possible to perform communication with a registered device in which a period of time until a validity term of registration is set to be a predetermined period of time, in a case where communication with the registered device cannot be performed, and gives notice to the registered device set to be communicable. Thereby, in a case where communication with a registered device cannot be temporarily performed, it is possible to make a user of the registered device recognize that a period of time until a validity term of registration is set to be a predetermined period of time.

[Sequence of Reference Example 2-3]

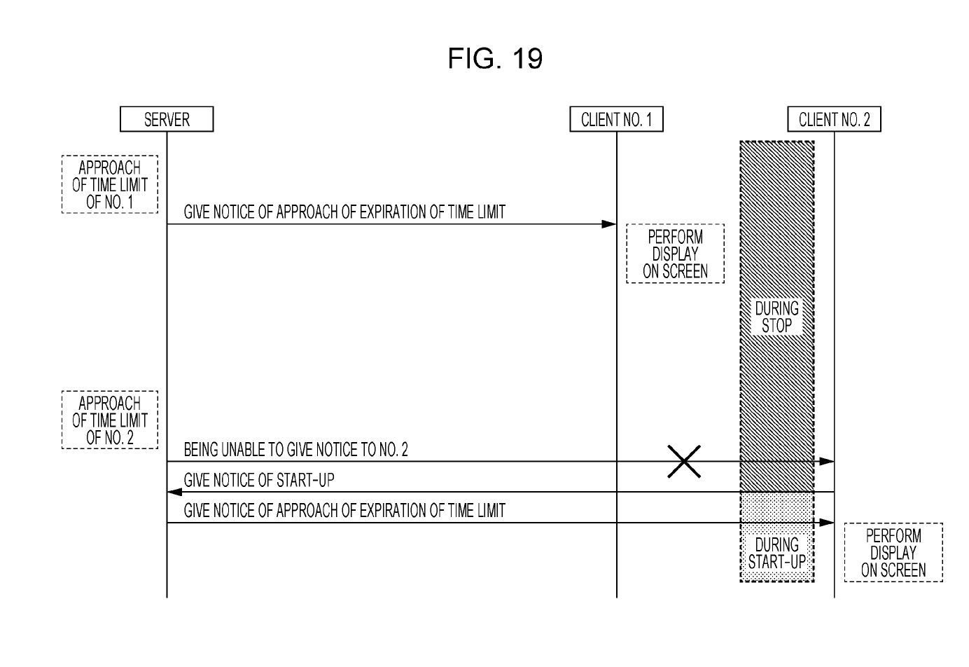

A flow of an operation of the content transmission system according to this reference example will be described with reference to FIG. 19. FIG. 19 is a diagram showing a sequence of operations of the server 20 of the content transmission system according to this reference example and two client devices (client devices 100c and 100d).

Here, one client device 100d out of the two client devices paired with the server 20 will be referred to as a client No. 1, and the other client device 100c will be referred to as a client No. 2.

As shown in FIG. 19, a period of time until a pairing validity term of the client No. 1 is set to be a predetermined period of time, the notification unit of the server 20 attempts to transmit a warning message to the client No. 1. Here, it is assumed that the client No. 1 can receive the warning message from the server 20.

The notification unit of the server 20 transmits a warning message to the client No. 1. The client No. 1 displays the warning message received from the server 20 on a screen. The details thereof have been described in the reference example 2-1 described above, and thus a description thereof will not be iterated.

Thereafter, a period of time until a pairing validity term of the client No. 2 is set to be a predetermined period of time, the notification unit of the server 20 attempts to transmit a warning message to the client No. 2. Here, it is assumed that the client No. 2 cannot receive the warning message from the server 20 due to not being in a start-up state.

Since a warning message cannot be transmitted to the client No. 2, the notification unit of the server 20 stands by until the client No. 2 and the server 20 are set to be able to communicate with each other.

When the client No. 2 is set to be in a start-up state, the client No. 2 notifies the server 20 of the start-up thereof. Meanwhile, at this time, the server 20 may be notified that address information (for example, an address in an in-house LAN) for transmitting a message to the client No. 2.

When the client No. 2 and the server 20 are set to be able to communicate with each other, the notification unit of the server 20 transmits a warning message indicating the approach of a pairing validity term of the client No. 2 to the client No. 2. In addition, the client No. 2 displays the warning message received from the server 20 on a screen.

Meanwhile, here, a description has been given of an example in which a warning message is transmitted when a client device, which has not been in operation, is started up. However, for example, a configuration may also be adopted in which a warning message is transmitted when application software operating in a client device is in operation in a case where pairing is performed by the application software.

In addition, when a warning message is transmitted to the client No. 2, the notification unit of the server 20 may display a pairing validity term of the client No. 1 on a screen of the server 20 or may display the pairing validity term on the client No. 2. This is because there are also many users concerned about pairing terms of other devices when it is known that a pairing term of a certain device is approaching.

### Reference Example 2-4

In the reference examples 2-1 to 2-3 described above, a description has been given of an example in which the server 20 notifies a client device of the approach of a pairing validity term. However, when the server 20 is in a stopped state, the server cannot communicate with a client device and cannot receive a notice from the server 20. In addition, a client device placed in an environment where communication with the server 20 cannot be performed cannot also receive a notice from the server 20.

Consequently, in this reference example, a description will be given of a configuration in which a client device manages a pairing validity term of the client device and notifies a user of the client device of the approach of the pairing validity term when the pairing validity term is approaching. In other words, in the reference example 2-4, a description will be given of an example in which a registered device (client devices 100a to 100d) includes a notification unit giving notice that a period of time until a validity term (pairing validity term) of registration is set to be a predetermined period of time. Meanwhile, the client devices 100a to 100d have the same configuration as that of the server 1. That is, each of the client devices 100a to 100d includes a control unit, a storage unit, a communication unit, a display unit, an input unit, and the like (see FIG. 1). In addition, the control unit of each of the client devices 100a to 100d includes a notification unit that notifies a host device that a pairing validity term thereof is approaching.

In this reference example, the server 20 transmits pairing validity terms of the client devices 100a to 100d to the client devices 100a to 100d at the time of pairing with the client devices 100a to 100d.

The notification unit of each of the client devices 100a to 100d stores and manages the pairing validity term received from the server 20. In addition, when a period of time until the pairing validity term is set to be a predetermined period of time, the notification unit of each of the client devices 100a to 100d displays a warning message which is set in advance.

For this reason, even when the server 20 cannot communicate with the client devices 100a to 100d, it is possible to notify users of the client devices 100a to 100d that a pairing validity term is approaching.

[Sequence of Reference Example 2-4]

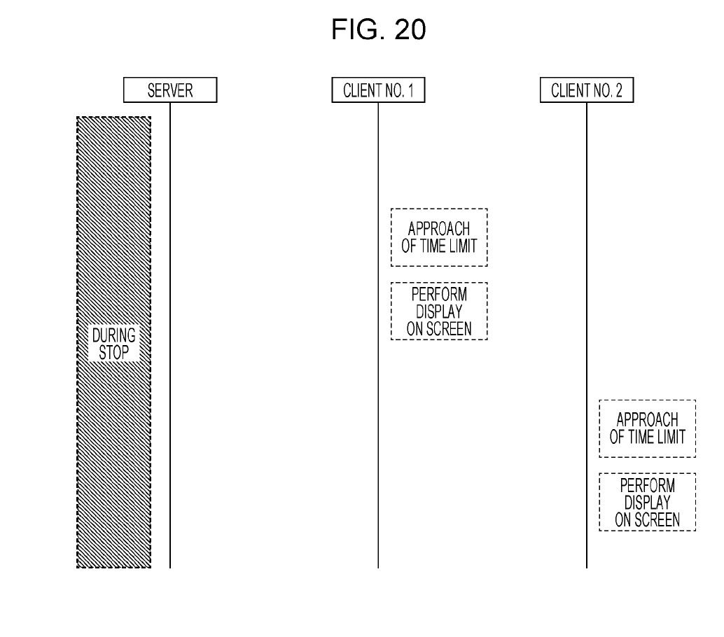

A flow of an operation of the content transmission system according to this reference example will be described with reference to FIG. 20. FIG. 20 is a diagram showing a sequence of operations of the server 20 of the content transmission system according to this reference example and two client devices 100c and 100d. Here, the client device 100d will be referred to as a client No. 1, and the client device 100c will be referred to as a client No. 2.

The client No. 1 and the client No. 2 are notified of a pairing validity term in advance by the server 20. In addition, each of the client No. 1 and the client No. 2 stores the pairing validity term given notice of in a storage unit (not shown).

As shown in FIG. 20, the server 20 is in a stopped state through the sequence, and thus it is assumed that the server cannot communicate with the client No. 1 and the client No. 2.

The notification unit of the client No. 1 monitors a period of time until a pairing validity term. In addition, when a period of time until a pairing validity term is set to be a predetermined period of time, the notification unit of the client No. 1 displays a warning message which is set in advance. In addition, the notification unit of the client No. 2 also monitors a period of time until a pairing validity term. The notification unit of the client No. 2 displays a warning message when a period of time until a pairing validity term is set to be a predetermined period of time, similar to the client No. 1.

### Reference Example 2-5

In a case where an application for receiving a warning message from a server (hereinafter, referred to as a warning reception application) is not a resident type in a client device, a user cannot perceive the presence of a warning message when the warning reception application is not started up.

Consequently, in this reference example, a description will be given of a configuration in which it is possible to notify a user of a client device of the approach of a pairing validity term even when a warning reception application is not started up in the client device.

In this reference example, the notification unit of the server 20 stores pairing validity terms of the client devices 100a to 100d in a storage device (not shown) at the time of pairing with the client devices 100a to 100d. In addition, the notification unit of the server 20 transmits a warning message for a client device in which a period of time until a pairing validity term is set to be a predetermined period of time, by an electronic mail (hereinafter, simply referred to as an e-mail). Meanwhile, an e-mail address is stored in advance during pairing or the like.

Thereby, a user can receive a warning message when there is a terminal capable of being connected to the Internet even when the user does not hold each of the client devices 100a to 100d in the user's hand (case of a web e-mail). In addition, the user does not also need to start up a warning reception application. Further, in general, a user frequently confirms an e-mail, and thus the user tends to perceive the reception of an e-mail of a warning message.

Meanwhile, means by which the server 20 transmits a warning message to the client devices 100a to 100d is not limited to an e-mail. The server 20 may transmit a warning message to the client devices 100a to 100d using another means via the Internet. In other words, a warning message may be uploaded on a network capable of being viewed by a user of a client device, or may be transmitted using communication means other than an e-mail.

In other words, the notification unit according to the reference example 2-5 allows the registered device to access information indicating that a period of time until a validity term of registration is set to be a predetermined period of time, through a predetermined communication network. Thereby, even when it is not possible to directly communicate with the registered device, it is possible to make a user of the registered device recognize that a period of time until a validity term of registration is set to be a predetermined period of time.

[Sequence of Reference Example 2-5]

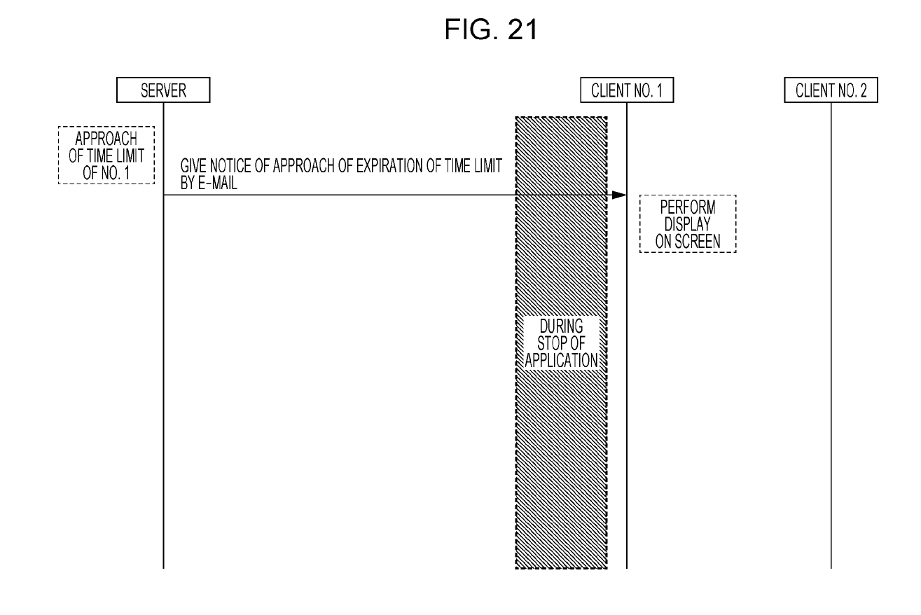

A flow of an operation of the content transmission system according to this reference example will be described with reference to FIG. 21. FIG. 21 is a diagram showing a sequence of operations of the server 20 of the content transmission system according to this reference example and the client devices 100c and 100d. Here, the client device 100d will be referred to as a client No. 1, and the client device 100c will be referred to as a client No. 2.

In the following description, it is assumed that a warning reception application is in a stopped state in the client No. 1 and the client No. 1 cannot receive a warning message from the server 20.

As shown in FIG. 21, when a period of time until a pairing validity term of the client No. 1 is set to be a predetermined period of time, the notification unit of the server 20 transmits a warning message to an e-mail address which is set in advance.

A user of the client No. 2 confirms the warning message by application software for viewing an e-mail. Thereby, the user can recognize that a pairing validity term of the client No. 2 is approaching.

### Reference Example 2-6

In the reference example 2-5 described above, a description has been given of a configuration in which the server 20 transmits an e-mail of a warning message to an e-mail address which is determined in advance through the Internet. However, in a case where a power supply of the server 20 is turned off or the server 20 cannot be connected to the Internet for some reason, the server 20 cannot transmit an e-mail of a warning message.

Consequently, in this reference example, a description will be given of a configuration in which another server (client information management server) which is capable of being connected to the Internet transmits a warning message to client devices 100a to 100d through means (for example, an e-mail) via the Internet.

In this reference example, a server 20 transmits pairing validity terms of client devices 100a to 100d, client information for specifying the client devices 100a to 100d, and an e-mail address associated with the client information of each of the client devices 100a to 100d to a client information management server which is another server connected to the Internet, at the time of pairing with the client devices 100a to 100d.

Here, the client information includes, for example, device type names of the client devices 100a to 100d and user names of the client devices 100a to 100d.

The client information management server manages pairing validity terms of the client devices 100a to 100d. In addition, the client information management server transmits a warning message to an e-mail address associated with a client device in which a period of time until a pairing validity term is set to be a predetermined period of time, through an e-mail with respect to the client device. In other words, in the reference example 2-6, a description will be given of an example in which the client information management server includes a notification unit that gives notice that a period of time until a validity term (pairing validity term) of registration is set to be a predetermined period of time. Meanwhile, the client information management server has the same configuration as that of the server 1. That is, the client information management server includes a control unit, a storage unit, a communication unit, a display unit, an input unit, and the like (see FIG. 1). In addition, the control unit of the client information management server includes the above-mentioned notification unit.

Accordingly, even when the above-mentioned warning reception application has not been started up and the server 20 cannot transmit an e-mail, a user can open an e-mail in a client device and can confirm a warning message. In addition, when the e-mail is a web e-mail, a user can receive a warning message by a terminal capable of being connected to the Internet even when the user does not hold each of the client devices 100a to 100d in the user's hand.

Meanwhile, means by which the client information management server transmits a warning message to the client devices 100a to 100d is not limited to an e-mail. The client information management server may transmit a warning message to the client devices 100a to 100d using another means via the Internet or the like.

[Sequence of Reference Example 2-6]

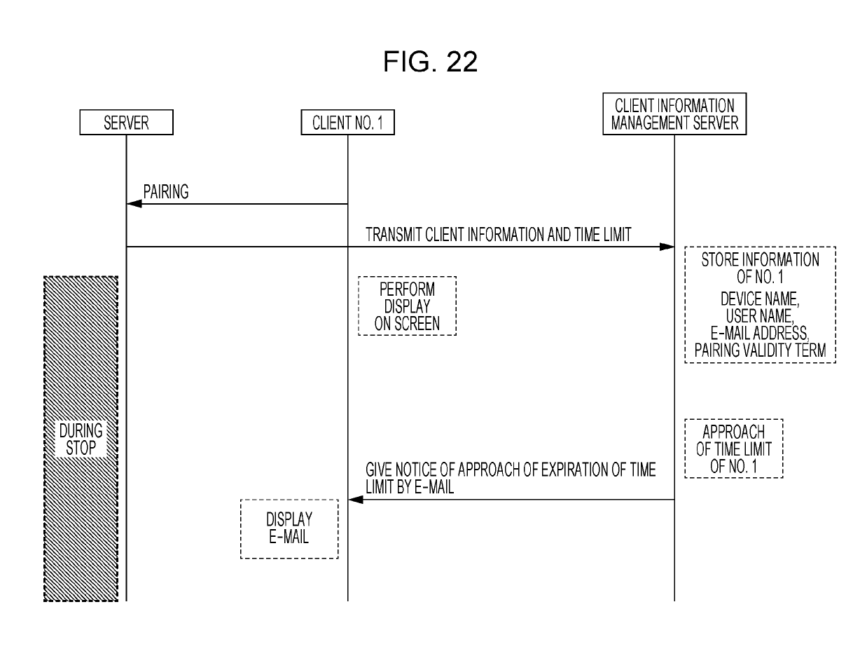

A flow of an operation of the content transmission system according to this reference example will be described with reference to FIG. 22. FIG. 22 is a diagram showing a sequence of operations of the server 20 of the content transmission system according to this reference example, the client device 100d, and an e-mail receiving server. Here, the client device 100d will be referred to as a client No. 1.

As shown in FIG. 22, first, the client No. 1 is paired with the server 20. At this time, the server 20 transmits a pairing validity term of the client No. 1, client information of the client No. 1, and an e-mail address to the client information management server.

Thereafter, it is assumed that the server 20 is in a stopped state and cannot communicate with the client No. 1.

The notification unit of the client information management server manages the pairing validity term of the client No. 1 which is received from the server 20. In addition, the notification unit of the client information management server transmits an e-mail of a warning message to an e-mail address associated with the client information of the client No. 1 when a period of time until the pairing validity term of the client No. 1 is set to be a predetermined period of time. Thereby, a user of the client No. 1 can confirm the warning message by an e-mail.

[Implementation Example Based on Software]

The notification unit of the control unit 2 of the server 20 according to each of the reference examples 2-1 to 2-6 described above may be realized by a logic circuit (hardware) which is formed in an integrated circuit (IC) chip or the like, or may be realized by software using a central processing unit (CPU).

In the latter case, the server 20 includes a CPU that executes a command of a program which is software realizing functions, a read only memory (ROM) or a storage device (each referred to as a “recording medium”) in which the above-mentioned program and various pieces of data are recorded so as to be readable by a computer (or a CPU), a random access memory (RAM) that develops the program, and the like. In addition, the computer (or the CPU) reads the program from the recording medium and executes the program, thereby achieving the object of the invention according to each of the reference examples 2-1 to 2-6. The recording medium to be used may be a “non-transitory tangible medium” such as a tape, a disc, a card, a semiconductor memory, or a programmable logic circuit. In addition, the program may be supplied to the computer through any transmission medium (a communication network, broadcast waves, or the like) which is capable of transmitting the program. Meanwhile, the invention according to each of the reference examples 2-1 to 2-6 may be implemented in the form of a data signal, embedded in a carrier wave, in which the program is embodied by electronic transmission. The same is true of the notification unit included in each of the client devices 100a to 100d and the client information management server.

### Reference Example 3-1

In a case where a pairing validity term is set as described above, pairing becomes invalid when the pairing validity term expires due to the overdue pairing validity term (for example, three months since the last pairing) without updating the pairing.

However, in a case where pairing validity term is excessively short (or excessively long), a user may forget updating a pairing validity term. In addition, when the user has not used a client device for a long period of time and attempts to use the client device now, the user may perceive the expiration of a pairing validity term. In this case, when there is a restriction that pairing can be performed only through an in-house LAN, it is possible to perform pairing only when going home once, which leads to a considerable inconvenience. Consequently, in this reference example, a description will be given of a configuration in which the expiration of a pairing validity term is prevented.

In the content transmission system of this reference example, in a case where a client device is placed in a house (within a valid range of an in-house LAN constituted by a group having the same IP as that of a server), a server 20 or client devices 100a to 100d update a validity term of pairing on a regular basis. Meanwhile, here, it is assumed that pairing can be updated only from the inside of a house. More specifically, a validity term of the pairing is updated by performing the pairing again from the inside of a house. However, a configuration in which pairing can be updated from the outside of a house may also be adopted.

Meanwhile, the server 20 according to the reference example 3-1 has the same configuration as that of the server 1 described in the first and second embodiments described above. That is, the server 20 includes a control unit 2, a storage unit 3, a communication unit 4, a display unit 5, an input unit 6, and a content memory 7 (see FIG. 1). However, as described below, the function of the control unit 2 is different from those in the above-described embodiments.

An information processing apparatus (server 20) according to the reference example 3-1 is an information processing apparatus that manages the registration of a registered device (client devices 100a to 100d) which is registered in advance in a content transmission system that transmits a content to the registered device in response to a request for viewing which is received from the registered device. A control unit (2) includes an updating unit that updates a validity term (pairing validity term) of registration of the registered device on a regular basis in a case where the registered device is connected to the same local area network (in-house LAN) as that of the information processing apparatus. Meanwhile, the updating unit may prompt a user to perform updating. In this case, the updating unit updates a validity term only when the user agrees with the updating.

In addition, each of the client devices 100a to 100d has the same configuration as that of the server 1. That is, each of the client devices 100a to 100d includes a control unit, a storage unit, a communication unit, a display unit, an input unit, and the like (see FIG. 1). In addition, the control unit of each of the client devices 100a to 100d may include the updating unit. In this case, a validity term (pairing validity term) is updated under the control of the client devices 100a to 100d.

[Sequence of Reference Example 3-1]

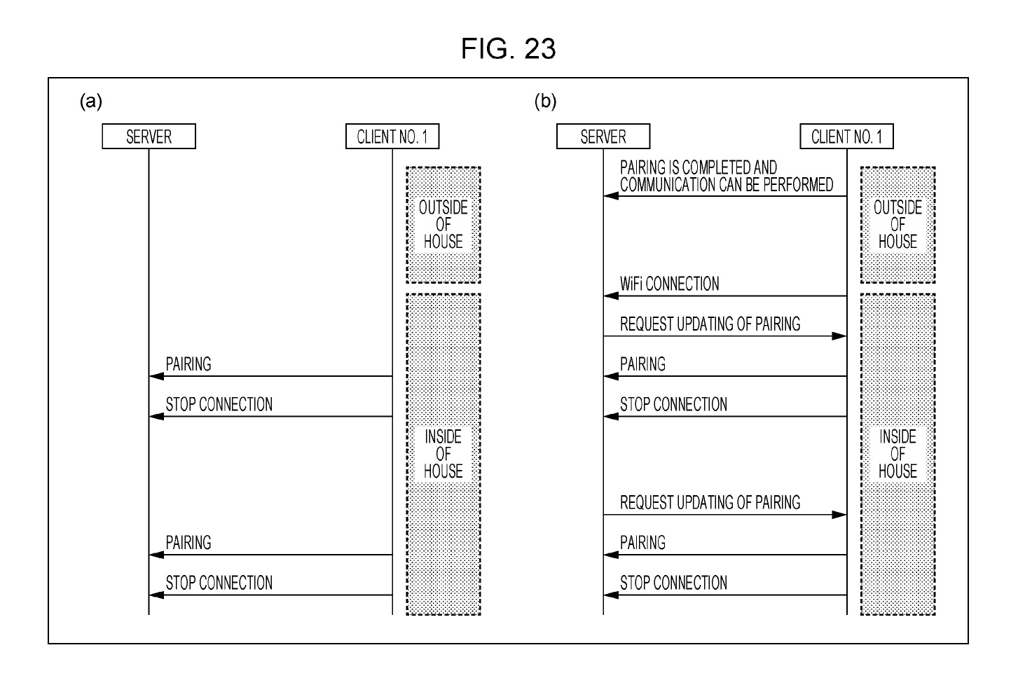

A flow of an operation of the content transmission system according to this reference example will be described with reference to (a) and (b) of FIG. 23. Here, (a) and (b) of FIG. 23 are diagrams showing a sequence of operations of the server 20 of the content transmission system according to this reference example and the client device 100d. Meanwhile, here, the client device 100d will be referred to as a client No. 1.

In addition, (a) of FIG. 23 shows a sequence for describing a pairing updating method in a case where a client device spontaneously updates pairing. Meanwhile, it is assumed that the server 20 and the client No. 1 are paired with each other in advance. In addition, it is assumed that the client No. 1 is notified of a pairing validity term by the server 20.

As shown in the drawing, the client No. 1 moves from the outside of a house to the inside of the house (connected to an in-house LAN). In addition, when a predetermined period of time (a period of time shorter than a pairing validity term since. For example, one week or one day in a case where a validity term is three months) has elapsed since the last pairing, the updating unit of the client No. 1 transmits a request for pairing to the server 20 to thereby perform pairing with the server 20 again. Thereby, a pairing validity term is reset. After the termination of pairing, the updating unit of the client No. 1 terminates connection with the server 20. This is because connection for the updating of pairing is sufficiently performed in a short period of time.

Meanwhile, on the assumption that a user does not desire to perform updating, the updating unit of the client No. 1 may display a screen for selecting whether to update pairing, and may transmit a request for pairing in a case where the user of the host device selects the possibility of updating.

Thereafter, when a predetermined period of time has elapsed since the previous pairing, the updating unit of the client No. 1 requests the server 20 to perform pairing as described above, to thereby update a pairing validity term.

Next, an example in which the necessity of updating of pairing is inquired from the server 20 will be described with reference to (b) of FIG. 23. As shown in the drawing, the client No. 1 is paired with the server 20 and can communicate with (receive a content from) the server 20 from the outside of a house.

The client No. 1 having moved into a house is connected to an in-house LAN by WiFi (registered trademark). When a predetermined period of time has elapsed since the last pairing, the updating unit of the server 20 transmits a notification for inquiring whether to update a pairing validity term to the client No. 1. In addition, the client No. 1 notifies the server whether to update a validity term of pairing with the server 20. Meanwhile, whether to perform updating may be selected by a user.

In a case where the client No. 1 gives notice that a pairing validity term is updated, the updating unit of the server 20 performs pairing with the client No. 1 again to thereby update the pairing validity term. In addition, the client No. 1 terminates connection (WiFi connection) with the server 20 after the pairing is terminated. Meanwhile, in a case where the client No. 1 gives notice that a pairing validity term is not updated, the updating unit of the server 20 does not update the pairing validity term of the client No. 1.

Thereafter, when a predetermined period of time has elapsed since the updating of the previous pairing, the updating unit of the server 20 confirms the necessity of pairing with respect to the client No. 1 as described above.

### Reference Example 3-2

In an information processing apparatus (server 20) according to the reference example 3-2, the control unit (2) updates a viewing time limit (pairing validity term) of a content of a registered device (client devices 100a to 100d) at a point of time when a period of time until the viewing time limit of the content is set to be a predetermined period of time or less in the information processing apparatus according to the reference example 3-1.

In the reference example 3-1 described above, a description has been given of a configuration in which a validity term of pairing is updated on a regular basis. However, in this reference example, a description will be given of an example in which the server 20 or the client devices 100a to 100d update a validity term of pairing when the remaining period of time until a pairing validity term (remaining period of time) is set to be a predetermined period of time or less. In other words, the updating unit according to the reference example 3-2 updates a validity term of a registered device (client devices 100a to 100d) in which a period of time until a validity term (pairing validity term) of registration is set to be a predetermined period of time in a case where the registered device is connected to the same local area network (in-house LAN) as that of the information processing apparatus (server 20). Meanwhile, the updating unit may be included in a control unit of the registered device (client devices 100a to 100d). In addition, the updating unit updates a validity term only when a user agrees with the updating.

[Sequence of Reference Example 3-2]

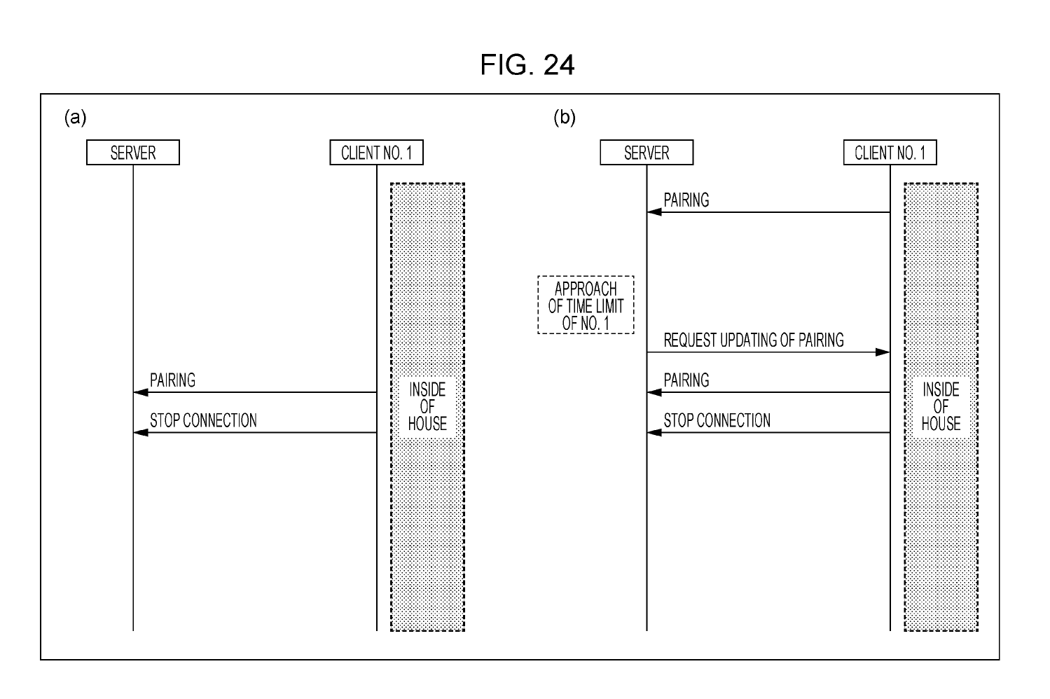

A flow of an operation of the content transmission system according to this reference example will be described with reference to (a) and (b) of FIG. 24. Here, (a) and (b) of FIG. 24 are diagrams showing a sequence of operations of the server 20 of the content transmission system according to this reference example and the client device 100d. Meanwhile, here, the client device 100d will be referred to as a client No. 1. In addition, the server 20 and the client No. 1 are already paired with each other, and it is assumed that the client No. 1 is notified of a pairing validity term by the server 20.

In addition, (a) of FIG. 24 shows a sequence for describing a pairing updating method in a case where a client device spontaneously updates pairing. As shown in the drawing, the client No. 1 is placed in a house through the sequence.

When a remaining period of time until a pairing validity term is set to be a predetermined period of time or less, the updating unit of the client No. 1 transmits a request for pairing to the server 20. Meanwhile, on the assumption that a user does not desire updating, the updating unit of the client No. 1 may display a screen for selecting whether to update pairing, and may transmit a request for pairing in a case where the user of the host device selects the possibility of updating. In addition, the updating unit of the client No. 1 terminates connection with the server 20 after the pairing is terminated. Meanwhile, although not shown in the drawing, the server 20 notifies the client No. 1 of a pairing validity term after updating.

Thereafter, when a remaining period of time until a pairing validity term after updating is set to be a predetermined period of time or less, the updating unit of the client No. 1 transmits a request for pairing as described above to thereby update pairing.

Next, an example in which the necessity of updating of pairing is inquired from the server 20 will be described with reference to (b) of FIG. 24. The updating unit of the server 20 monitors a remaining period of time until a pairing validity term after performing pairing with the client No. 1, and requests the client No. 1 to update pairing when the validity term approaches (a predetermined period of time before the validity term).

In addition, in a case where the client No. 1 gives notices of the updating of a pairing validity term, the updating unit of the server 20 performs pairing with the client No. 1 again to thereby update the pairing validity term. After the pairing is terminated, the client No. 1 terminates connection with the server 20.

[Implementation Example Based on Software]

The notification unit of the control unit 2 of the server 20 according to each of the reference examples 3-1 and 3-2 described above may be realized by a logic circuit (hardware) which is formed in an integrated circuit (IC) chip or the like, or may be realized by software using a central processing unit (CPU).

In the latter case, the server 20 includes a CPU that executes a command of a program which is software realizing functions, a read only memory (ROM) or a storage device (each referred to as a “recording medium”) in which the above-mentioned program and various pieces of data are recorded so as to be readable by a computer (or a CPU), a random access memory (RAM) that develops the program, and the like. In addition, the computer (or the CPU) reads the program from the recording medium and executes the program, thereby achieving the object of the invention according to each of the reference examples 3-1 and 3-2. The recording medium to be used may be a “non-transitory tangible medium” such as a tape, a disc, a card, a semiconductor memory, or a programmable logic circuit. In addition, the program may be supplied to the computer through any transmission medium (a communication network, broadcast waves, or the like) which is capable of transmitting the program. Meanwhile, the invention according to each of the reference examples 3-1 and 3-2 may be implemented in the form of a data signal, embedded in a carrier wave, in which the program is embodied by electronic transmission. The same is true of the notification unit included in each of the client devices 100a to 100d.

### Reference Example 4-1

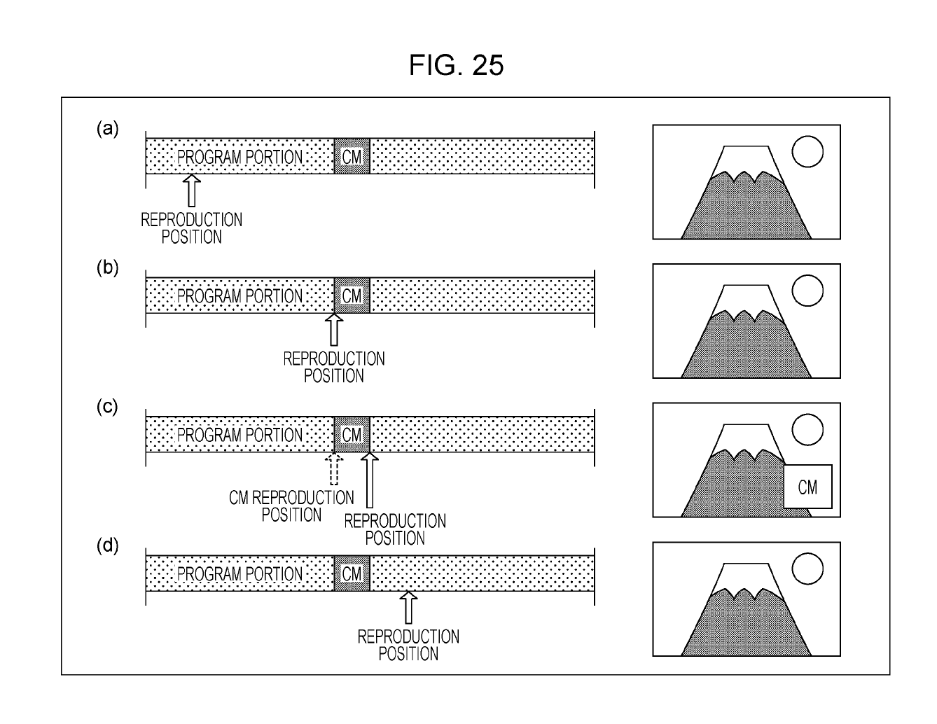

Another reference example of the invention will be described with reference to (a) to (d) of FIG. 25.

Hitherto, there has been known a device having a function of skipping the reproduction of a CM included in a recorded broadcasting content (recorded television program). Due to users who use such a function, it is desired that such a CM skipping function can be used even when a broadcasting content is viewed from the outside of a house in the above-described content transmission system. This is because there are many users who feel a sense of incongruity in that CM skipping is not allowed to be performed outside a house in spite of CM skipping being allowed in a house.

On the other hand, the viewing of a CM being not increased is a problem for a broadcasting organization in spite of an increase in the viewing of a television program, and thus it is desired that users also view a CM.

Consequently, in this reference example, a description will be given of a configuration in which a user can be made to view a CM while obtaining the same effects as those of a CM skipping function. Meanwhile, a content transmission system of this reference example includes a server 20 and client devices 100a to 100d, similar to the other reference examples. In other words, the server 20 according to this reference example includes a control unit 2, a storage unit 3, a communication unit 4, a display unit 5, an input unit 6, and a content memory 7 (see FIG. 1), similar to the server 1 described in the first and second embodiments described above. However, as described below, the function of the control unit 2 is different from those in the above-described embodiments.

A reproduction device (client devices 100a to 100d) according to the reference example 4-1 is a reproduction device that reproduces a content requested and acquired from the content transmission system. The reproduction device includes a reproduction position changing unit that changes (skips) a reproduction position of a content being reproduced, and a reproduction unit that reproduces an inserted content which is inserted into the content together with the content of which the reproduction position is changed, in a case where the reproduction position is changed by the reproduction position changing unit so that the inserted content inserted into the content is not reproduced. Thereby, it is also possible to view an inserted content (for example, a CM) while changing a reproduction position.

[Sequence of Reference Example 4-1]

An operation of the content transmission system according to this reference example will be described with reference to (a) and (d) of FIG. 25. Here, (a) to (d) of FIG. 25 are diagrams showing a flow of the reproduction of a recorded content in a client device of the content transmission system according to this reference example.

A band-shaped figure shown on the left side of each of (a) to (d) of FIG. 25 indicates a configuration of a recorded content, and the horizontal direction in the drawing indicates a time. As shown in the drawing, a recorded content includes a program portion and a CM portion which is inserted into the program portion. In addition, in the drawing, a reproduction position is shown by an arrow, and an image displayed at the reproduction position is shown on the right side of the drawing.

Meanwhile, hereinafter, a description will be given on the assumption that the transmission of at least portions of a recorded content, which is shown in FIG. 25, from the server 20 to the client device 100a is completed and the portions are stored. In addition, the client device 100a reproduces the stored recorded content while decoding the recorded content. Meanwhile, the client device is any of the client devices 100a to 100d.

In (a) of FIG. 25, a reproduction position is included in a program portion, and an image of the television program is displayed on a screen of a client device.

In (b) of FIG. 25, a reproduction position is a position at which a CM is started. A user performs a skipping operation (a 30-second jump, a fast-forwarding, and the like are included) of skipping a reproduction position when the reproduction of a CM is started. In addition, the reproduction position changing unit of the client device 100a receives the operation.

Here, the reproduction position changing unit of the client device 100a determines whether or not a portion to be skipped includes a CM portion when the reproduction position changing unit receives a skipping operation. In a case where a CM portion is not included, the reproduction position changing unit of the client device 100a reproduces a recorded content from a reproduction position after the skipping.

On the other hand, in a case where a CM portion is included, the reproduction position changing unit of the client device 100a notifies a reproduction unit of information (for example, a starting time and a termination time of a CM) which indicates a CM portion to be skipped. In addition, the reproduction unit having been notified displays an image of the skipped CM on a child screen, which is smaller than a main screen, in the main screen displaying an image of a recorded content. In other words, as shown on the right side of (c) of FIG. 25, a CM is displayed by picture in picture (PinP). In addition, the reproduction position changing unit of the client device 100a displays a recorded content which is reproduced from a reproduction position after skipping, on the main screen. Meanwhile, the client device 100a decodes both a CM portion and a program portion in parallel during a period of time of PinP display.

Thereafter, as shown in (d) of FIG. 25, when the reproduction position further moves forward and the reproduction of the CM portion is terminated, the reproduction unit of the client device 100a terminates the reproduction of the CM, and thus the PinP display is terminated.

### Reference Example 4-2

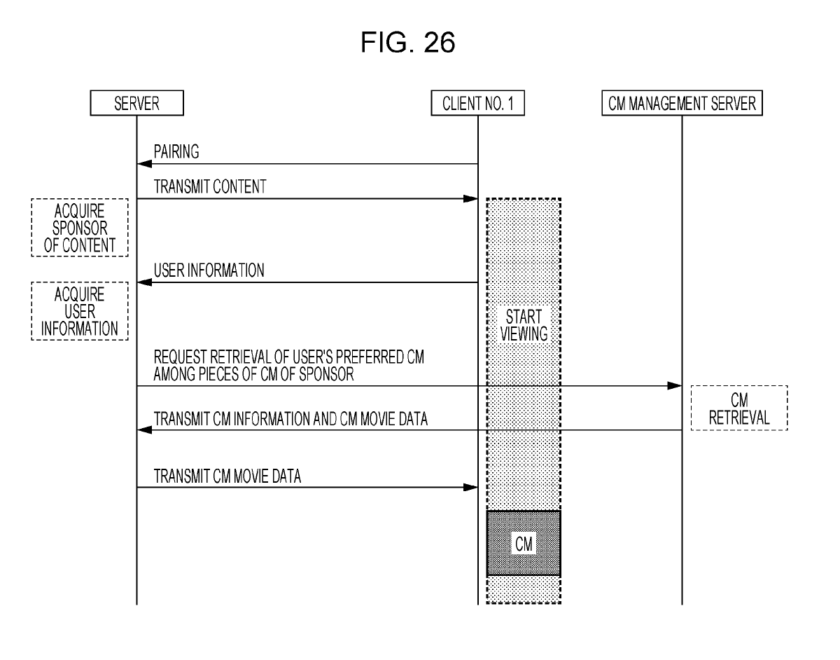

Another reference example of the invention will be described with reference to FIG. 26.

In the above-described content transmission system, a content is transmitted to a specific client device which is paired. For this reason, it is possible to transmit a content according to each client device or the user thereof. In this reference example, a description will be given of a configuration in which a CM included in a content to be transmitted to a client device is switched to a CM according to the client device. Thereby, it is possible to view a more effective CM in response to the taste of a user of the client device. Meanwhile, a content transmission system of this reference example includes a server 20 and client devices 100a to 100d, similar to the other reference examples. In addition, each of the client devices 100a to 100d according to this reference example includes a control unit 2, a storage unit 3, a communication unit 4, a display unit 5, an input unit 6, and the like, similar to the server 1 (see FIG. 1). In addition, the control unit of each of the client devices 100a to 100d includes an acquisition unit and a reproduction unit that are described below.

A reproduction device (client devices 100a to 100d) according to the reference example 4-2 is a reproduction device that reproduces a content requested and acquired from the content transmission system. The reproduction device includes an acquisition unit that acquires another inserted content in a case where a content being reproduced includes an inserted content (CM), and a reproduction unit that reproduces the inserted content acquired by the acquisition unit instead of an inserted content included in the content being reproduced. Thereby, it is possible to reproduce an inserted content according to the reproduction device or the user thereof, instead of a default inserted content.

In addition, the server 20 according to the reference example 4-2 also has the same configuration as that of the server 1. That is, the server 20 includes a control unit 2, a storage unit 3, a communication unit 4, a display unit 5, an input unit 6, and a content memory 7 (see FIG. 1). In addition, the control unit of the server 20 includes an acquisition unit and a transmission unit that are described below.

An information processing apparatus (server 20) according to the reference example 4-2 is an information processing apparatus that transmits a content to a reproduction device (client devices 100a to 100d) which is registered in advance in response to a request for viewing received from the reproduction device. The information processing apparatus includes an acquisition unit that acquires another inserted content in a case where an inserted content (CM) is included in the content transmitted to the reproduction device, and a transmission unit that transmits the inserted content acquired by the acquisition unit to the reproduction device. Thereby, it is possible to acquire an inserted content according to the reproduction device and the user thereof and to reproduce the acquired inserted content instead of a default inserted content.

[Sequence of Reference Example 4-2]

A flow of an operation of the content transmission system according to this reference example will be described with reference to FIG. 26. FIG. 26 is a diagram showing a sequence of operations of the server 20 of the content transmission system according to this reference example, the client device 100d, and a CM management server. Meanwhile, here, the client device 100d will be referred to as a client No. 1. In addition, the CM management server is a server that manages a CM content based on user information, such as age, sex, and a residential area, for each sponsor.

As shown in FIG. 26, first, the client No. 1 requests pairing from the server 20. The client No. 1 requests the server 20 to transmit a content after pairing with the server 20 is completed.

The transmission unit of the server 20 transmits the requested content to the client No. 1. In addition, the acquisition unit of the server 20 determines a sponsor of the content transmitted by the transmission unit.

On the other hand, the reproduction unit of the client No. 1 starts to reproduce a content received from the server 20, and the acquisition unit of the client No. 1 transmits user information (age, sex, a user's positional information, and the like) of the client No. 1 to the server 20.

Next, the acquisition unit of the server 20 notifies the CM management server of the received user information and the specified sponsor, and requests the CM management server to retrieve a CM content, which is to a taste of a user having the user information, among CM contents of the sponsor. Next, the CM management server retrieves a CM content on the basis of the request. For example, a CM content based on an area such as a store close to the position of a user of the client No. 1. In addition, the CM management server transmits CM information indicating contents of a CM content detected and movie data which is substance of the CM content to the server 20, and the transmission unit of the server 20 transmits the movie data to the client No. 1.

Next, the reproduction unit of the client No. 1 decodes the received movie data of the CM content, stores the decoded data in a buffer different from that of a content being output, and switches an output buffer when a reproduction position of the content falls within a reproduction range of a CM. Thereby, the received CM content is replaced with the original CM and is output.

Meanwhile, in the above-mentioned example, replacement with a CM content based on user information is performed, but a CM content after replacement may be specified without using user information. For example, it is not necessary to use user information for replacement with a latest CM content.

[Implementation Example Based on Software]

The control blocks (particularly, the reproduction position changing unit, the acquisition unit, and the reproduction unit) of the client devices 100a to 100d according to the reference examples 4-1 to 4-2 and the control block (particularly, the acquisition unit and transmission unit) of the server 20 may be realized by a logic circuit (hardware) which is formed in an integrated circuit (IC) chip or the like, or may be realized by software using a central processing unit (CPU).

In the latter case, the client devices 100a to 100d and the server 20 include a CPU that executes a command of a program which is software realizing functions, a read only memory (ROM) or a storage device (each referred to as a “recording medium”) in which the above-mentioned program and various pieces of data are recorded so as to be readable by a computer (or a CPU), a random access memory (RAM) that develops the program, and the like. In addition, the computer (or the CPU) reads the program from the recording medium and executes the program, thereby achieving the object of the invention according to each of the reference examples 4-1 and 4-2. The recording medium to be used may be a “non-transitory tangible medium” such as a tape, a disc, a card, a semiconductor memory, or a programmable logic circuit. In addition, the program may be supplied to the computer through any transmission medium (a communication network, broadcast waves, or the like) which is capable of transmitting the program. Meanwhile, the invention according to each of the reference examples 4-1 and 4-2 may be implemented in the form of a data signal, embedded in a carrier wave, in which the program is embodied by electronic transmission.

[Overview]

An information processing apparatus (server 1) according to a first aspect of the invention is an information processing apparatus that receives a request for registration of a device in a content transmission system that transmits a content to a registered device registered (paired) in advance in response to a request received from the registered device. The information processing apparatus includes a cancellation candidate selection unit (pairing management unit 11) that selects a cancellation candidate which is a candidate for the cancellation of registration among registered devices in a case where a request for registration is received in a state where the number of registered devices reaches an upper limit, and a candidate presentation unit (pairing management unit 11) that presents the cancellation candidate to a user to thereby make the user select whether to cancel the registration (pairing) of the cancellation candidate.

According to the above-described configuration, in a case where a request for registration is received in a state where the number of registered devices reaches an upper limit, a cancellation candidate is selected among registered devices and is presented to a user, and the user is made to select whether to cancel the registration of the cancellation candidate. Accordingly, it is possible to easily select a device which is appropriate as a target for the cancellation of registration, as compared to a case where a registered device which is a target for the cancellation of registration among all of the registered devices.

Meanwhile, a user who is a target for the presentation of a cancellation candidate may be a user who has made a new request for registration, or may be another user (for example, a user having authority to cancel registration, or the like). In addition, in a case where a target for presentation is a user who has made a new request for registration, the presentation may be performed by a device having made a new request for registration or may be performed by another device (for example, a content transmission apparatus).

In an information processing apparatus according to a second aspect of the invention, the content transmission apparatus (server 1) that transmits a content to the registered device in the first aspect is an apparatus capable of transmitting a content to a device being connected to a local area network (in-house LAN) to which the content transmission apparatus is connected, and a device communicating with the content transmission apparatus through an external communication network (the Internet). The information processing apparatus further includes a device detection unit (position determination unit 13) that detects a registered device connected to the local area network or a registered device located at a position capable of being connected thereto. The cancellation candidate selection unit selects a cancellation candidate among registered devices detected by the device detection unit.

According to the above-described configuration, a registered device being connected to a local area network or a registered device located at a position capable of being connected thereto is selected as a cancellation candidate. This is effective in a case where, for example, only a device connected to a local area network is registered. This is because it is possible to perform registration again even when the registration of a device against a user's intention is canceled. In addition, the above-described configuration is effective in a case where a content can be received from a content transmission apparatus without performing registration with respect to, for example, a device connected to a local area network. This is because there is no change in a state where a content can be received even when the registration is canceled.

According to a third aspect of the invention, the information processing apparatus of the second aspect includes a stay time specification unit (in-house stay time specification unit 14) that specifies a cumulative time for which the registered device is connected to the local area network or a cumulative time for which the registered device is located at a position capable of being connected thereto, and the cancellation candidate selection unit preferentially sets a registered device having a longer cumulative time specified by the stay time specification unit among registered devices detected by the device detection unit, as a cancellation candidate.

A registered device having a longer cumulative time for which the registered device is connected to a local area network or a longer cumulative time for which the registered device is located at a position capable of being connected thereto is mainly used within the local area network, and there is a strong possibility that the registered device is rarely used for the reception of a content from the outside of a local area network. Accordingly, according to the above-described configuration, there is a strong possibility of the registered device is not used for the reception of a content from the outside of a local area network, and thus it is possible to set a registered device appropriate for cancellation as a cancellation candidate. In addition, it is also possible to prevent a device, which is not used for the viewing of a content from the outside of a local area network over a long period of time, from remaining registered.

According to a fourth aspect of the invention, in the information processing apparatus of the second or third aspect, the registration device includes a frequency specification unit (frequency specification unit 15) that specifies a frequency at which a content is acquired by the registered device that makes a request to the content transmission apparatus from the outside of the local area network, and the cancellation candidate selection unit sets a registered device having a lower frequency specified by the frequency specification unit as a cancellation candidate in a case where a registered device is not detected by the device detection unit.

According to the above-described configuration, a registered device having a lower frequency at which a content is acquired from the outside of a local area network is preferentially set as a cancellation candidate. Accordingly, a registered device which has a low frequency at which the registered device is used for the reception of a content from the outside of a local area network and which is appropriate for cancellation can be set as a cancellation candidate.

According to a fifth aspect of the invention, in the information processing apparatus according to any one of the first to fourth aspects, a content transmission apparatus that transmits a content to the registered device is an apparatus capable of transmitting a content to a device being connected to a local area network to which the content transmission apparatus is connected, and a device communicating with the content transmission apparatus through an external communication network. The information processing apparatus further includes a non-reception period specification unit that acquires non-reception period information indicating a period of time for which the registered device does not receive a content from the content transmission apparatus outside the local area network. The cancellation candidate selection unit preferentially sets a registered device having a longer period of time for which a content is not received, as a cancellation candidate on the basis of the non-reception period information.

According to the above-described configuration, a registered device having a longer period of time for which a content is not received from a content transmission apparatus outside a local area network is preferentially set as a cancellation candidate. Accordingly, a registered device which is appropriate for cancellation due to a long period of time for which a content is not received from the content transmission apparatus outside a local area network can be set as a cancellation candidate. Meanwhile, the period of time may be a recent non-reception period (elapsed time since the last reception) or may be a cumulative non-reception period.

According to a sixth aspect of the invention, the information processing apparatus according to any one of the first to fifth aspects includes a use situation specification unit that specifies a cumulative use time obtained by cumulating a time for which the registered device is used in a predetermined mode or a use frequency at which the registered device is used in a predetermined mode. The cancellation candidate selection unit preferentially sets a registered device having a shorter cumulative use time specified by the use situation specification unit or a registered device having a lower use frequency, as a cancellation candidate.

According to the above-described configuration, a registered device having a shorter cumulative use time or a lower use frequency is preferentially set as a cancellation candidate. Accordingly, a registered device which is appropriate for cancellation due to a shorter cumulative use time and a lower use frequency can be set as a cancellation candidate. Meanwhile, the predetermined mode may be a use mode such as the reception of a content or may be another use mode such as, for example, the display of an image on a device.

According to a seventh aspect of the invention, the information processing apparatus according to any of the first to sixth aspects includes a priority determination unit that determines whether or not a device which is a transmission source of the request for registration has a registration priority lower than that of the registered device in accordance with a reference point which is determined in advance. In a case where the priority determination unit determines that the device which is a transmission source of the request for registration has a registration priority lower than that of the registered device, the candidate presentation unit notifies the user of a result of the determination to thereby make the user select whether to cancel the request for registration.

In the above-described aspects, a cancellation candidate is selected from a registered device, but a case is also considered in which a registered device registered prior to a device which is a transmission source of a request for registration has to be preferentially registered. Consequently, according to the above-described configuration, in a case where it is determined that the device which is a transmission source of a request for registration has a registration priority lower than that of the registered device, a result of the determination is notified to the user to thereby make the user select whether to cancel a request for registration. Accordingly, it is possible to prevent the registration of a device having a high priority from being cancelled in order to register a device having a low priority.

The information processing apparatus according to each aspect of the invention may be realized by a computer. In this case, the scope of the invention also encompasses a control program of the information processing apparatus for realizing the information processing apparatus by a computer by causing the computer to operate as each unit included in the information processing apparatus, and a computer readable recording medium having the control program recorded thereon.

[Another Expression of the Invention]

The invention can also be expressed as follows.

A remote viewing corresponding device (master device) has a list of paired remote viewing terminals (hereinafter, slave devices). In a case where the number of slave devices reaches an upper limit during the reception of a request for pairing, a slave device being requested to be paired or a paired slave device is determined as a candidate of a slave device which is not a target for pairing (a request of the slave device being requested to be paired is not received at present, or the pairing of the paired slave device is canceled) so that the number of slave devices falls within the range of the above-mentioned upper limit.

In addition, the remote viewing corresponding device includes a unit that detects whether a slave device is present inside a house or outside a house, and changes a determination method of determining a candidate of a slave device which is not subjected to pairing between the slave device being requested to be paired and the paired slave device in accordance with a result of the determination of whether the slave device being requested to be paired and the paired slave device are present inside a house or outside a house.

Further, when all of the slave devices including a slave device being requested to be paired and a paired slave device include a slave device which is present outside a house and a slave device which is present inside a house, the remote viewing corresponding device preferentially cancels the pairing of a paired slave device which is present inside a house.

Further, the remote viewing corresponding device includes a unit that acquires a time for which a paired slave device is continuously present inside a house, a paired slave device having a longer time for which the slave device is present inside a house, among paired slave devices that are present inside a house, is preferentially set as a pairing cancellation candidate.

Further, the remote viewing corresponding device includes a unit that acquires a frequency at which remote viewing is performed by a paired slave device. When a paired slave device is not present inside a house, the pairing of a paired slave device having a lower frequency of remote viewing, among paired slave devices that are present outside a house, is preferentially canceled.

The invention is not limited to the above-described embodiments, and may be modified in various ways within the scope defined in the claims. Embodiments obtained by appropriately combining pieces of technical means disclosed in different embodiments are also included in the technical scope of the invention. Further, new technical features can be formed by combining pieces of technical means disclosed in the embodiments.

### INDUSTRIAL APPLICABILITY

The invention can be used in a content transmission system that transmits a content to a registered device.

### REFERENCE SIGNS LIST

1 SERVER (INFORMATION PROCESSING APPARATUS, CONTENT TRANSMISSION APPARATUS)
11 PAIRING MANAGEMENT UNIT (CANCELLATION CANDIDATE SELECTION UNIT, CANDIDATE PRESENTATION UNIT)
13 POSITION DETERMINATION UNIT (DEVICE DETECTION UNIT)
14 IN-HOUSE STAY TIME SPECIFICATION UNIT (STAY TIME SPECIFICATION UNIT)
15 FREQUENCY SPECIFICATION UNIT
100a to 100d CLIENT DEVICE (DEVICE, REGISTERED DEVICE, CANCELLATION CANDIDATE)

1-8. (canceled)

9. An information processing apparatus that receives a request for registration of a device in a content transmission system that transmits a content to a registered device, the registered device being registered in advance, the information processing apparatus comprising:
a cancellation candidate selection unit that selects a cancellation candidate which is a candidate for cancellation of registration among registered devices in a case where a request for registration is received in a state where the number of registered devices reaches an upper limit,
the content being transmitted to the registered device from a content transmission apparatus, the content transmission apparatus being capable of transmitting a content to a device being connected to a local area network to which the content transmission apparatus is connected and a device communicating with the content transmission apparatus through an external communication network.

10. The information processing apparatus according to claim 9, further comprising:
a candidate presentation unit that presents the cancellation candidate to a user to thereby make the user select whether to cancel registration of the cancellation candidate.

11. The information processing apparatus according to claim 9, further comprising:
a device detection unit that detects a registered device being connected to the local area network or a registered device located at a position capable of being connected thereto,
wherein the cancellation candidate selection unit selects a cancellation candidate among registered devices detected by the device detection unit.

12. The information processing apparatus according to claim 10, further comprising:
a stay time specification unit that specifies a cumulative time for which the registered device is connected to the local area network or a cumulative time for which the registered device is located at a position capable of being connected to the local area network,
wherein the cancellation candidate selection unit preferentially sets a registered device having a longer cumulative time specified by the stay time specification unit among the registered devices detected by the device detection unit, as a cancellation candidate.

13. The information processing apparatus according to claim 11, further comprising:
a frequency specification unit that specifies a frequency at which a content is acquired by the registered device that makes a request of the content to the content transmission apparatus from an outside of the local area network,
wherein in a case where a registered device is not detected by the device detection unit, the cancellation candidate selection unit preferentially sets a registered device having a lower frequency specified by the frequency specification unit, as a cancellation candidate.

14. The information processing apparatus according to claim 9, further comprising:
wherein a content transmission apparatus transmitting a content to the registered device is an apparatus capable of transmitting a content to a device being connected to a local area network to which the content transmission apparatus is connected and a device communicating with the content transmission apparatus through an external communication network, the information processing apparatus further comprising:
a non-reception period specification unit that acquires non-reception period information indicating a period of time for which the registered device does not receive a content from the content transmission apparatus through the external communication network,
wherein the cancellation candidate selection unit preferentially sets a registered device having a longer period of time for which a content is not received, as a cancellation candidate on the basis of the non-reception period information.

15. The information processing apparatus according to claim 9, further comprising:
a use situation specification unit that specifies a cumulative use time obtained by cumulating a time for which the registered device is used in a predetermined mode or a use frequency at which the registered device is used in a predetermined mode,
wherein the cancellation candidate selection unit preferentially sets a registered device having a shorter cumulative use time specified by the use situation specification unit or a registered device having a lower use frequency, as a cancellation candidate.

16. The information processing apparatus according to claim 10, further comprising:
a priority determination unit that determines whether or not a device which is a transmission source of the request for registration has a registration priority lower than that of the registered device, in accordance with a reference point which is determined in advance,
wherein in a case where the priority determination unit determines that the device which is a transmission source of the request for registration has a registration priority lower than that of the registered device, the candidate presentation unit notifies the user of a result of the determination to thereby make the user select whether to cancel the request for registration.

17. A non-transitory computer-readable recording medium, in which a control program causing a computer to function as the cancellation candidate selection unit of the information processing apparatus according to claim 9 is recorded.

18. A method for controlling an information processing apparatus that receives a request for registration of a device in a content transmission system that transmits a content to a registered device in response to a request received from the registered device, the registered device being registered in advance,
the method comprising the step of selecting a cancellation candidate which is a candidate for cancellation of registration among registered devices in a case where a request for registration is received in a state where the number of registered devices reaches an upper limit,
the content being transmitted to the registered device from a content transmission apparatus, the content transmission apparatus being capable of transmitting a content to a device being connected to a local area network to which the content transmission apparatus is connected and a device communicating with the content transmission apparatus through an external communication network.
